(19) United States
(12) Patent Application Publication
(10) Pub. No.: US 2005/0035199 A1
(43) Pub. Date: Feb. 17, 2005

(54) Voter interface for electronic voting system for the visually impaired

(76) Inventors: John Goci, Westland, MI (US); Skender Gocaj, (US); John Goci, Westland, MI (US); Shkendija Gocaj, Howell, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/826,808

(22) Filed: Apr. 15, 2004

Related U.S. Application Data
(63) Continuation-in-part of application No. PCT/US03/11305, filed on Apr. 11, 2003.
Application No. PCT/US03/11305 is a continuation of application No. 10/120,221, filed on Apr. 11, 2002.
(60) Provisional application No. 60/463,498, filed on Apr. 16, 2003.
(60) Provisional application No. 60/439,895, filed on Jan. 14, 2003.

(51) Int. Cl. G06F 17/60

(52) U.S. Cl. 235/386

(57) ABSTRACT

A voting station in an electronic voting system is programmed for predetermined election contests taking place on a predetermined election day. The voting station includes a display screen for displaying textual and pictorial information and a user selection device for selecting items from said textual and pictorial information to indicate preferences of a voter. In one preferred embodiment, the display screen and user selection device is integrated as a touch-screen display. The display screen presents a slate of candidates for an elected office, each of the candidates being displayed as a selection item including at least a textual name identifier. The voter manipulates the user selection device to select a desired one of the candidates. Then the display screen presents an enlarged representation of information corresponding to the desired candidate together with a confirmation selection item and a cancel selection item. The voter manipulates the user selection device to select either the confirmation selection item or the cancel selection item. If the confirmation selection item is selected, then the display screen progresses through remaining election contests until the voter has confirmed a selection in each election contest. The display screen presents all voter selections on a review screen and presents choices to the voter to change any of the selections. After the voter confirms no further changes, the voting station outputs the voter selections.

### PARENT CASE TEXT

This application claims the benefit of Provisional Application 60/463,498 filed Apr. 16, 2003, and is a continuation-in-part of PCT Application, International Application Number PCT/US03/11305, filed Apr. 11, 2003, which claims the benefit of U.S. Non-Provisional Application No. 10/120,221, filed Apr. 11, 2002, and of U.S. Provisional Application No 60/439,895, filed Jan. 14, 2003.

### FIELD OF INVENTION

The present invention relates in general to a programmable, electronic voting system and a user interface for such a voting system, and a voter check-in system.

### BACKGROUND OF THE INVENTION

One of the most important foundations of a democracy is the right to vote. To ensure that each voter can effectively exercise that right and to ensure confidence in the results of any election, integrity of the process for casting and counting votes is paramount. The essential challenge is to achieve accurate identification of voter preferences while preserving voter anonymity.

Prior voting systems such as written paper ballots, punched cards, and mechanical switch panels have been overly complex and subject to numerous problems in connection with accurate recording and counting of votes. Due to the need to collect votes from a large number of voters in a short time, election officials have tried various techniques to reduce the time it takes for a voter to cast their ballot. Unfortunately, these have tended to create more voter confusion or have failed because of the deficiencies underlying the basic technologies used. The inaccuracies of vote counts and/or loss of votes that regularly occur have continued to raise much concern.

Electronic or computerized voting for governmental elections is now being investigated as an alternative for addressing some of the deficiencies of the prior art. However, a satisfactory system has remained elusive because of the many competing requirements for an acceptable voting system. For example, voter errors should be minimized or eliminated, but it is also desired that the amount of time required to complete a ballot should be a short as possible. Preferably, the vote must be maintained in a manner that allows a vote recount to take place. Public confidence in the integrity of electronic data storage, as well as the user friendliness of electronic or computer equipment and the “computer-phobia” felt by certain potential voters, must be taken into account. Furthermore, the readability (e.g., size) of text and/or non-native language abilities can create further confusion and errors. The foregoing problems have discouraged the adoption of electronic, computerized voting systems.

Further, conventional voting systems typically require visual recognition of the voter selections to be made, and fail to fully accommodate the needs of individuals who are visually impaired in that they may be blind or may have low vision, or who cannot read. These individuals may be discouraged from voting due to lack of independence or due to lack of certainty in successful completion of the voting process.

### SUMMARY OF THE INVENTION

The present invention provides a robust interface for an electronic voting system which reduces errors, builds voter confidence in electronic voting, and reduces the time it takes to complete a ballot, to tabulate vote counts, and to report them from local polling places to centralized authorities.

In one aspect of the invention, a method is provided for operating a voting station in an electronic voting system programmed for predetermined election contests taking place on a predetermined election day. The voting station includes a display screen for displaying textual and pictorial information and a user selection device for selecting items from said textual and pictorial information to indicate preferences of a voter. In one preferred embodiment, the display screen and user selection device is integrated as a touch-screen display. An identified voter is first authorized to cast an anonymous ballot using the voting station. The display screen presents a slate of candidates for an elected office, each of the candidates being displayed as a selection item including a textual name identifier and a photo. The voter manipulates the user selection device to select a desired one of the candidates. Then the display screen presents an enlarged representation of information corresponding to the desired candidate together with a confirmation selection item and a cancel selection item. The voter manipulates the user selection device to select either the confirmation selection item or the cancel selection item. If the cancel selection item is selected, then the display screen returns to presentation of the slate of candidates. If the confirmation selection item is selected, then the display screen progresses through remaining election contests until the voter has confirmed a selection in each election contest. The display screen presents all voter selections on a review screen and presents choices to the voter to change any of the selections. After the voter confirms no further changes, the voting station outputs the voter selections.

The voting system logic can also be applied to other processes such as surveying consumer acceptance of products.

According to other embodiments, the voting system may be utilized in an audio mode where selections are made in response to audio prompts. The audio mode is provided to assist a voter with impaired vision. According to one embodiment, the audio mode information may be provided to at least one additional person, such as a polling place worker, engaged to assist the voter.

According to one embodiment, the audio mode is provided with corresponding text and pictorial displays on the display monitor, each display corresponds to an audio prompt or to a voter selection made in response to an audio prompt. The audio mode with corresponding text and pictorial display is also provided to assist a voter with impaired vision or to provide information to at least one additional person, such as a polling place worker, engaged to assist the voter.

### BRIEF DESCRIPTION OF THE DRAWINGS

FIG. 1 is a hardware diagram showing an architecture of an electronic voting system.

FIGS. 2 through 4 are flowcharts showing a preferred method of the present invention.

FIGS. 5 through 18 show the appearance of a touch-screen display during operation of a preferred embodiment of the present invention.

FIG. 19 shows an example of a hardcopy ballot generated by the present invention.

### DETAILED DESCRIPTION OF THE PREFERRED EMBODIMENT

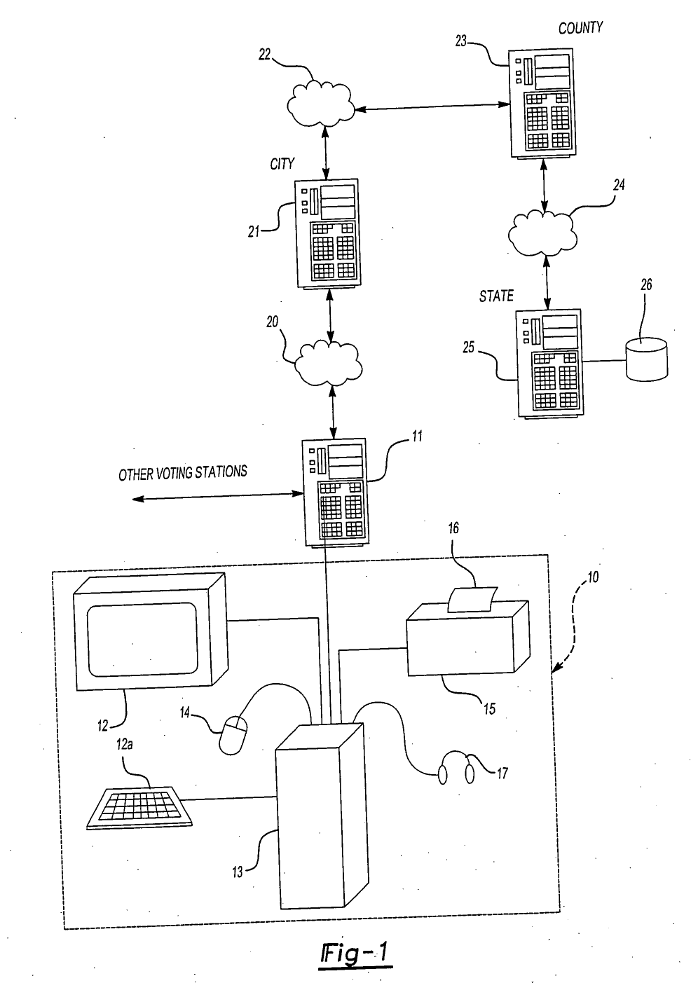

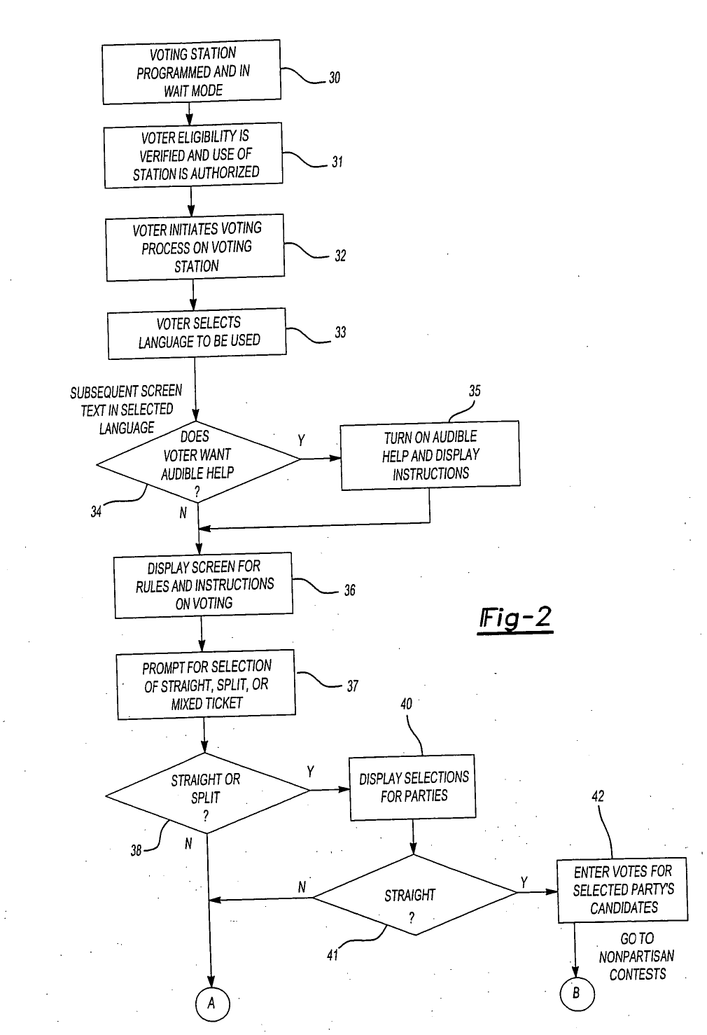

Referring to FIG. 1, an electronic voting system includes a voting station 10 coupled within a computer network to a local server 11 (e.g., located within a voting precinct or polling place and connected to other voting stations within the precinct). Voting station 10 is set-up to provide privacy during voting and includes a display monitor with integrated touch screen 12 connected to a workstation or personal computer 13 which is programmed to communicate with server 11 and to provide a voter interface for predetermined election contests taking place on a predetermined election day. Integrated display monitor/touch screen 12 displays textual and pictorial information and is responsive to voter manipulation for selecting items from the textual and pictorial information to indicate the voter's preferences. As an alternative to the touch screen selection device, a mouse 14 can be provided to make selections using the same graphical user interface on display monitor 12. A keyboard 12a with a Braille keyboard is attached to the computer for the visually handicapped.

For purposes of providing individual printed ballots reflective of the votes cast by each voter, a printer 15 is connected to computer 13 on which a ballot 16 is being printed. Headphones 17 are coupled to computer 13 which together provide an audio system that can be used to provide audible help to a voter (e.g., spoken instructions for those with limited reading literacy in the available languages or for those with eyesight limitations). For example, computer 13 includes a sound card and sound files have pre-recorded instructions in each of the predetermined languages.

Printed ballots may be collected and stored for use in vote recounts. Alternatively, the printed ballots could be collected and scanned using separate scanning equipment (not shown) for determining an official vote count for the respective precinct (e.g., if it is desired to electronically isolate the vote counting equipment). Preferably, the actual real-time vote tally is tabulated electronically via transmission over the computer network connection to precinct server 11. Server 11 is connected via a secure network 20 (e.g., a virtual private network or VPN over the Internet) to a city server in a city election office. The city server is also connected to other precinct servers (not shown). Server 21 is connected via a secure network 22 to a server 23 at the county level which collects vote data from the city servers within the county.

Likewise, a secure network 24 connects a server 25 in a state election office to all of the county servers. State server 25 is coupled to a master databank 26 for maintaining an official vote tabulation (e.g., for the state and federal election contests). A mainframe computer (not shown) may be provided for controlling database 26. Central vote accumulation may be performed at different levels depending upon the specific elective offices or the entities through which specific proposals are being made.

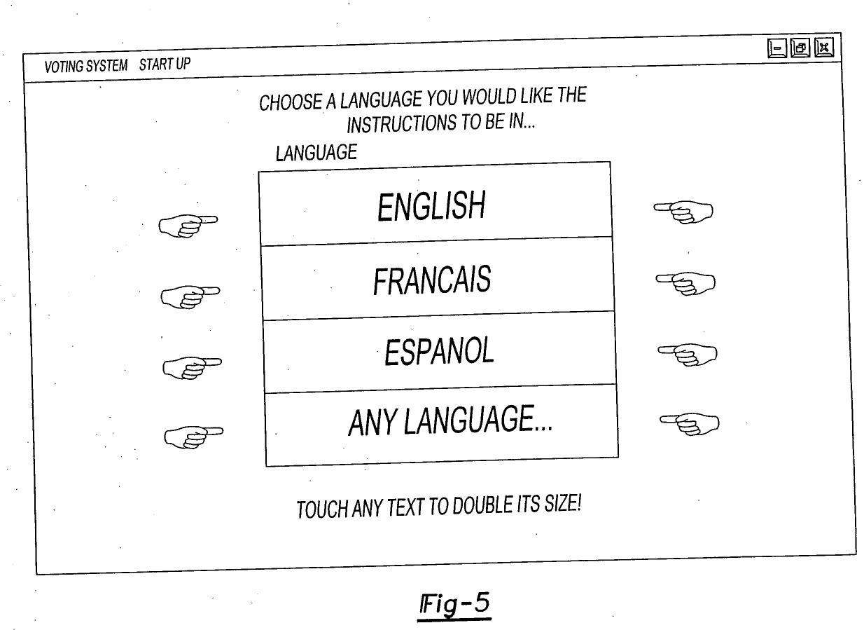

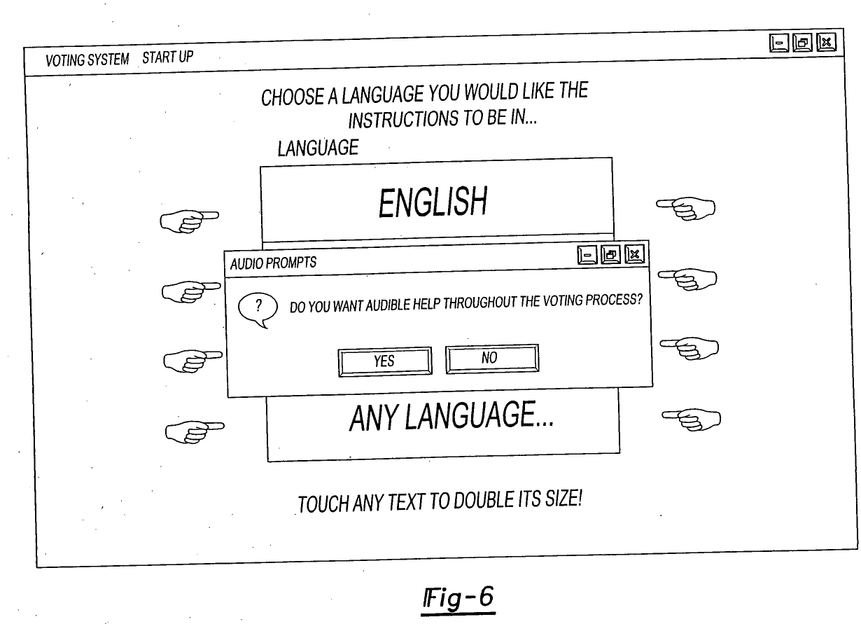

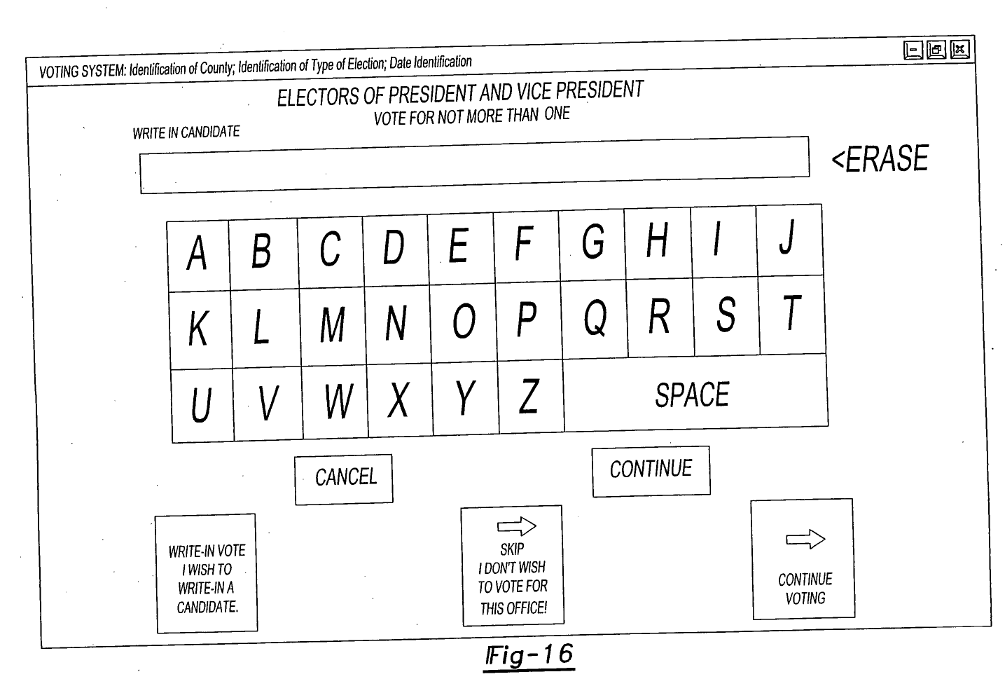

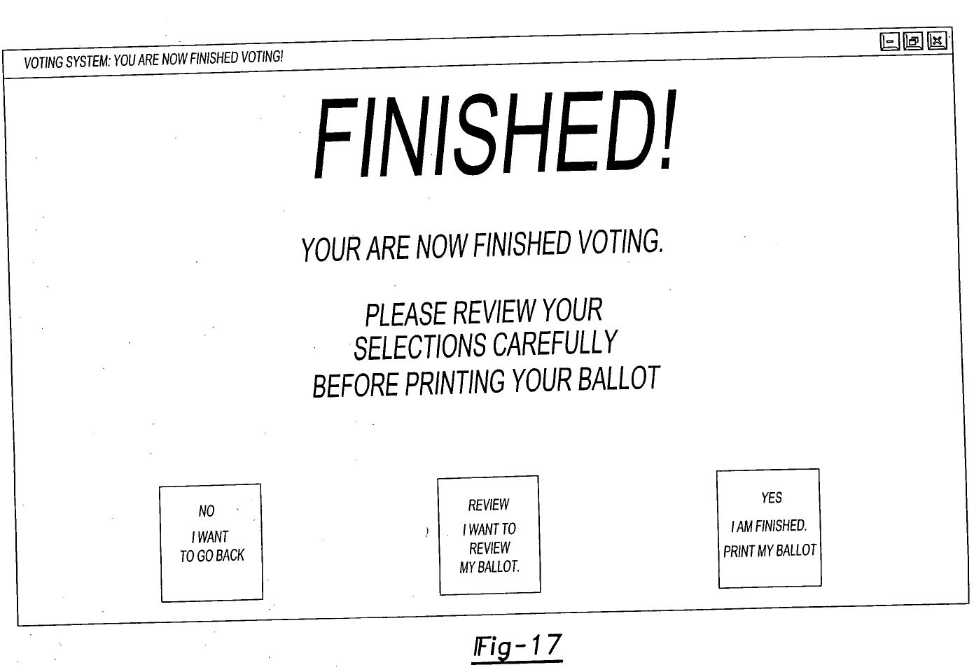

An operating method and an overall voter interface for the electronic voting system is shown in the flowcharts of FIGS. 2-4 which will be described in conjunction with the display contents (i.e., screen shots) in FIGS. 5-18.

Prior to use by a voter, a voting station is preprogrammed for the predetermined election contests (e.g., elected offices and ballot proposals) for an election being held on a predetermined election day. The voting station is initialized in a wait mode in step 30. A voter's identity and eligibility to vote are determined in step 31 and if eligible, then their use of the voting station is authorized. Identification and eligibility may be determined in any suitable manner, such as by presentation and manual acceptance of a signed voter's card or by electronic identification using fingerprints or other identifying characteristics. Identification and authorization may be conducted by the voting station itself. During the time that the voting station is in the wait mode, the display screen may show a message saying “Waiting for Next Voter. If You Need Help, Please Ask an Election Worker”. In step 32, an authorized voter approaches a voting station and initiates the process of voting.

In step 33, a voter selects the language that they prefer to use in the voting process. As shown in FIG. 5, a language selection screen (presented in a default language, such as English) includes selection items 100 (i.e., menu buttons) corresponding to the preprogrammed languages available. The voter may touch a desired button so that all subsequent screen text or other written instructions are provided in the desired language. In one preferred embodiment, the screen in FIG. 5 also alerts a voter to the fact that any text shown on a display screen (other than a selection item) can be enlarged (e.g., doubled in size) for making it easier to read by simply selecting (e.g., touching) the text.

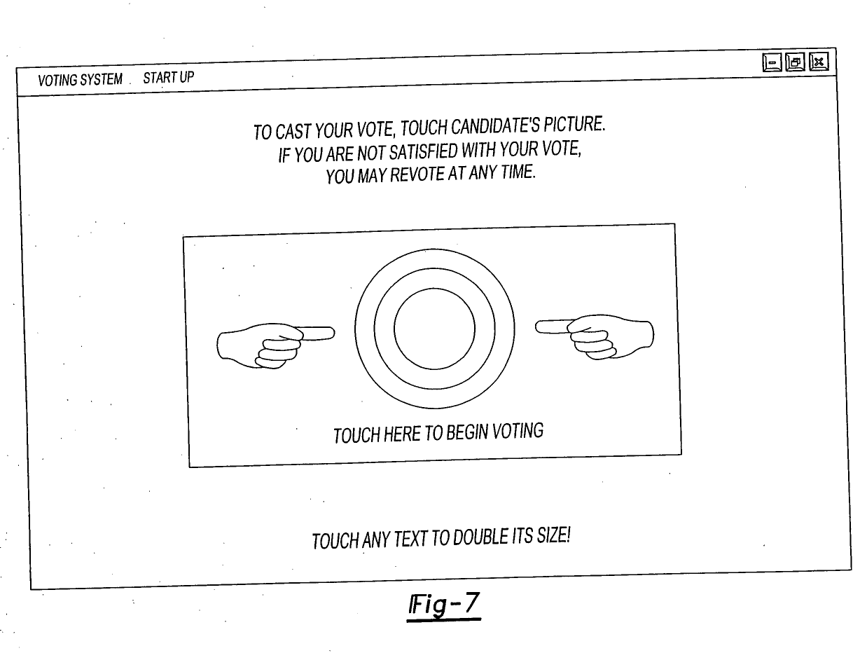

After a language is selected, the voter is prompted to indicate whether they desire audible (i.e., audio) help in step 34. The corresponding display screen is shown in FIG. 7. If audible help is desired, then the audible help function is turned on in step 35 while instructions for using the audio system (e.g., to put on the headphones) are displayed. If audio is turned on, then all subsequent display text or a predetermined portion thereof are audibly reproduced.

Once a language and the use of audible help are established, the instructions, any other text displays, and any audible help are provided in the selected language. Voting rules and instructions are presented to the voter in step 36. For example, FIG. 7 shows a screen explaining that to cast a vote for a candidate, the candidate's picture should be touched on the touch screen. After reading this explanation, the voter touches a target area to proceed to vote.

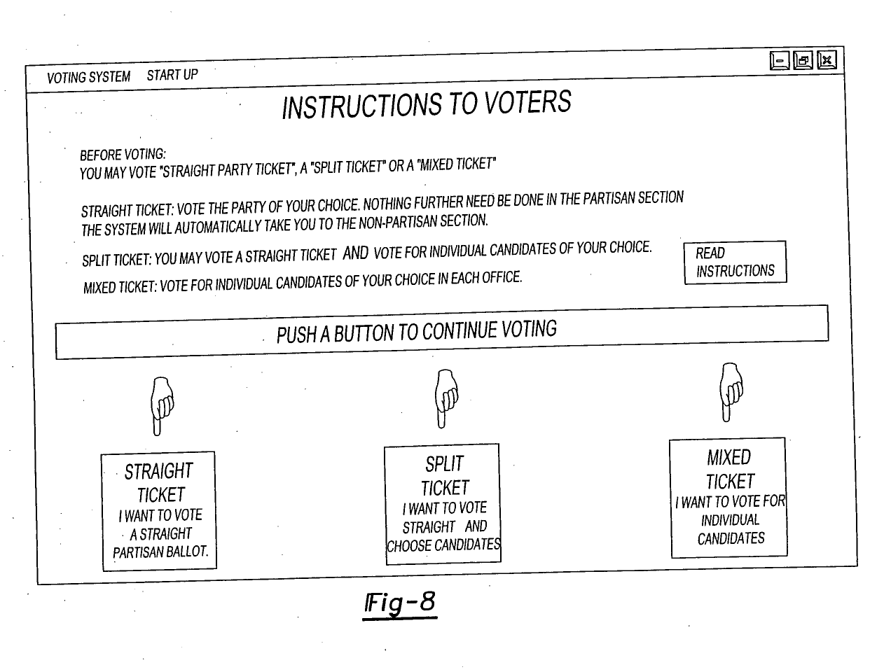

In step 37, the voter is prompted to select a voting mode from the choices of straight party ticket, split ticket, or mixed ticket. The corresponding screen is shown in FIG. 8. As explained on the screen, the straight party ticket mode allows the voter to choose a party. All votes are cast in the partisan portion of the election for candidates of the chosen party. Then the voter is taken to any nonpartisan or proposal sections of the election contests. In the split ticket mode, the votes for the partisan contests are initialized for candidates of the selected party but each contest is presented to the voter so that any individual votes can be changed. In mixed ticket mode, each contest is presented without any initialization of the votes.

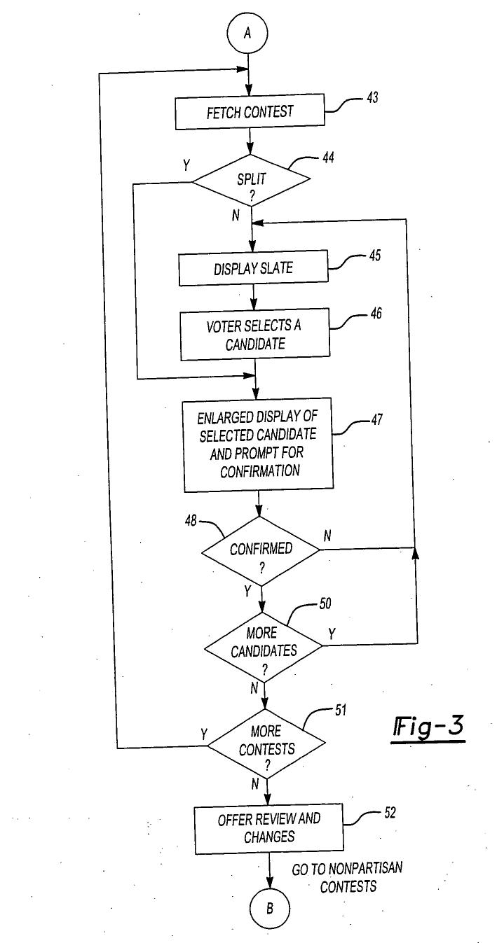

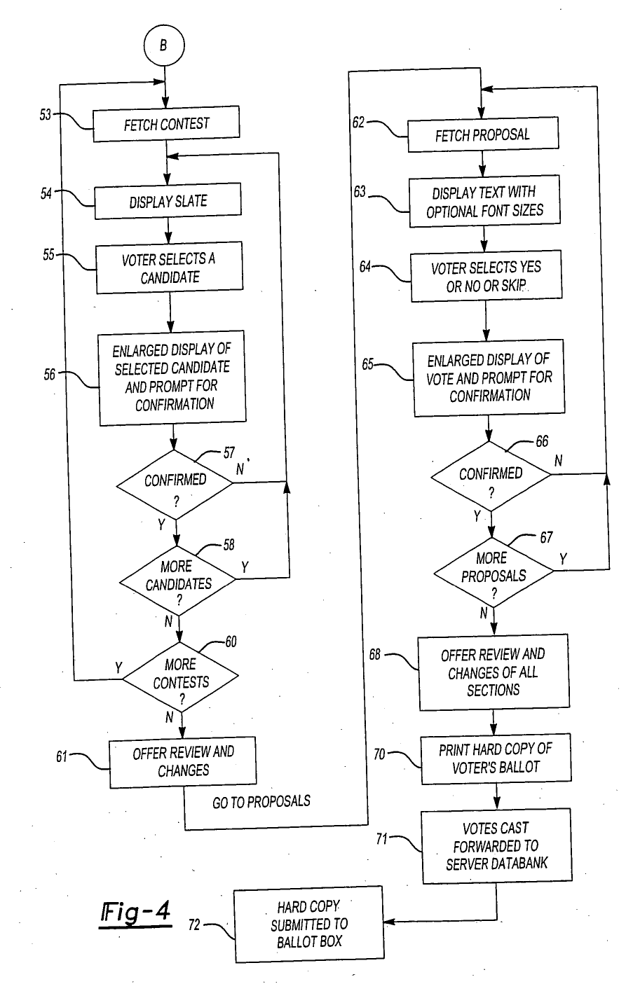

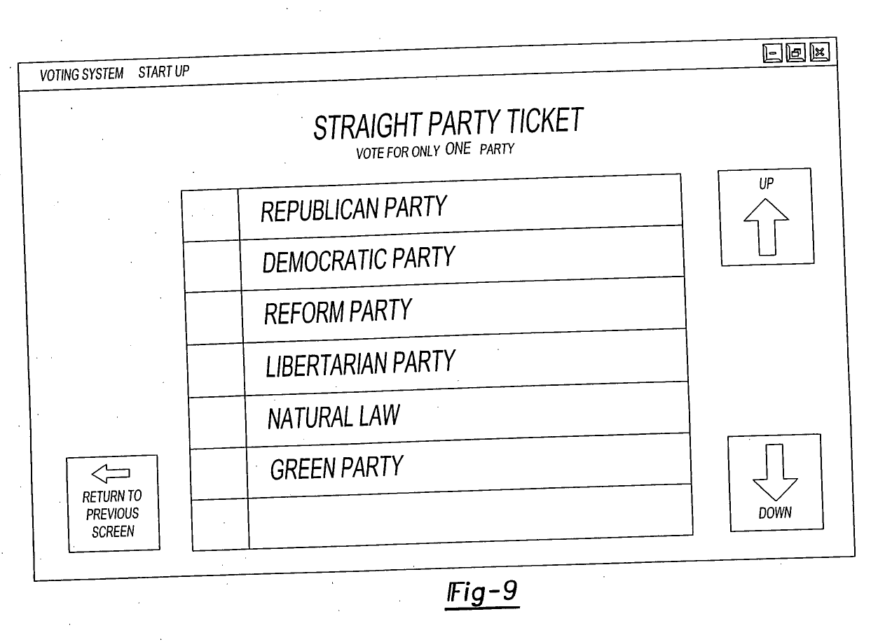

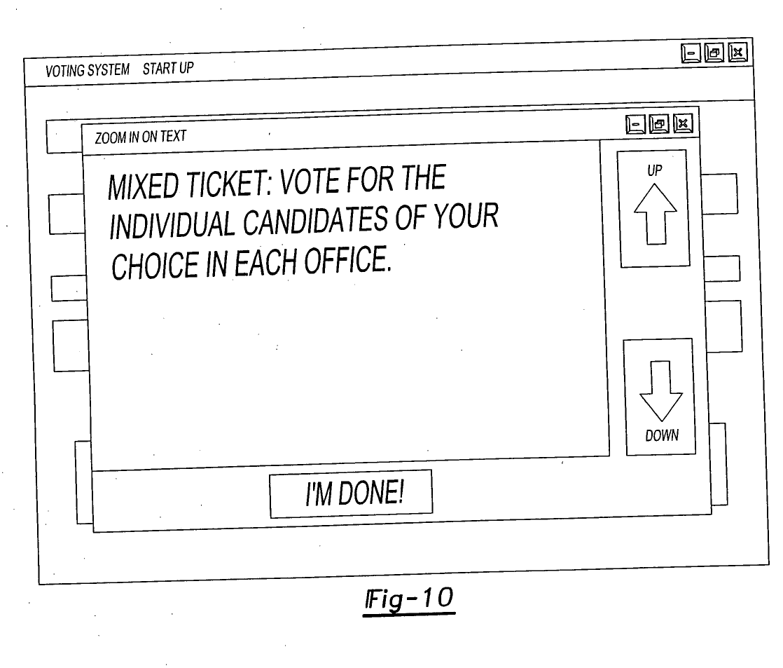

The voter selects “straight ticket” selection item 101, “split ticket” selection item 102, or “mixed ticket” selection item 103 on the screen of FIG. 8. In the operating method of FIG. 2, a check is made in step 38 to determine if the voter has selected either a straight ticket or a split ticket. If so, then the available political parties are displayed in step 40 and the voter touches the name of the desired party (the corresponding screen is shown in FIG. 9). A check is made in step 41 to determine if the straight ticket mode is selected. If it is, then votes are entered for the candidates of the selected party in step 42 and the method proceeds to any nonpartisan election contests at point B (which links to FIG. 4). If step 38 detects mixed ticket mode or if step 41 detects split ticket mode, then the method proceeds to the partisan election contests at point A (which links to FIG. 3). Additional instructions for the split ticket and mixed ticket modes may be shown, such as a mixed ticket message shown in FIG. 10.

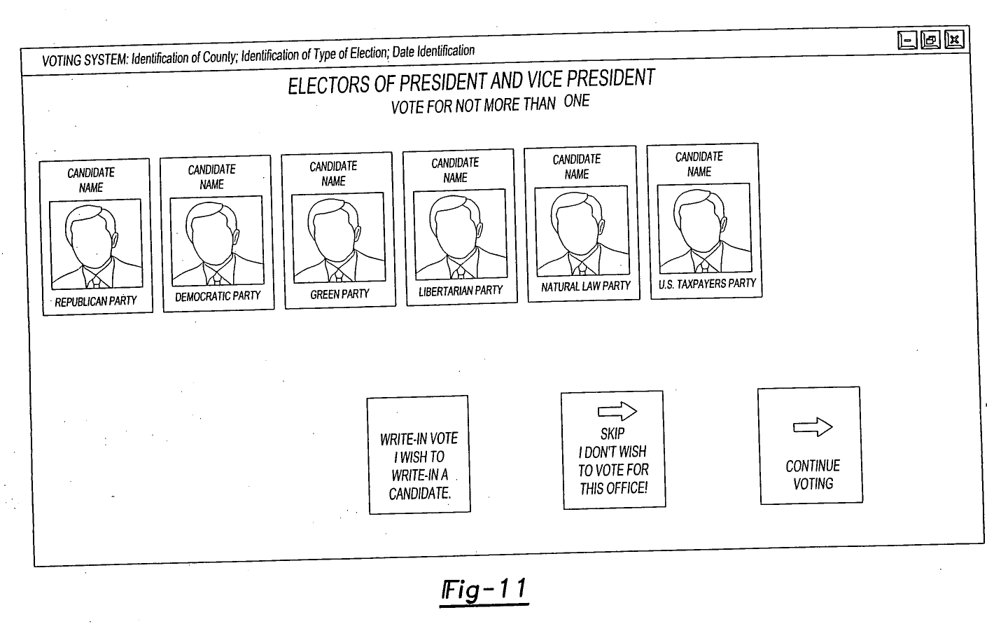

Proceeding from point A in FIG. 3, a first partisan contest is fetched in step 43. A check is made in step 44 for the split ticket mode. If not in split ticket mode (i.e., mixed ticket mode is active), then a slate of candidates for the current election contest is displayed in step 45. Each candidate is identified by at least a textual name identifier and preferably by a name, picture, and political party as shown in the screen view of FIG. 11. In step 46, the voter selects a candidate by touching the selection item block (containing the candidate's name, picture, and party) of their choice. Additional selection items may be provided for writing-in the name of a candidate (if appropriate) or for skipping the current election contest without entering a vote. If step 44 determines that voting is in split ticket mode (i.e., a preferred political party has been chosen), then the vote for the current contest is initialized to the candidate(s) of the chosen party and the method proceeds directly from step 44 to step 47.

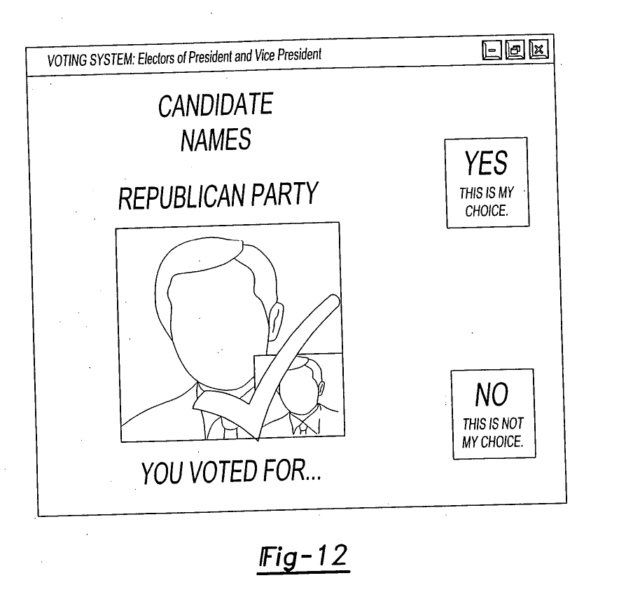

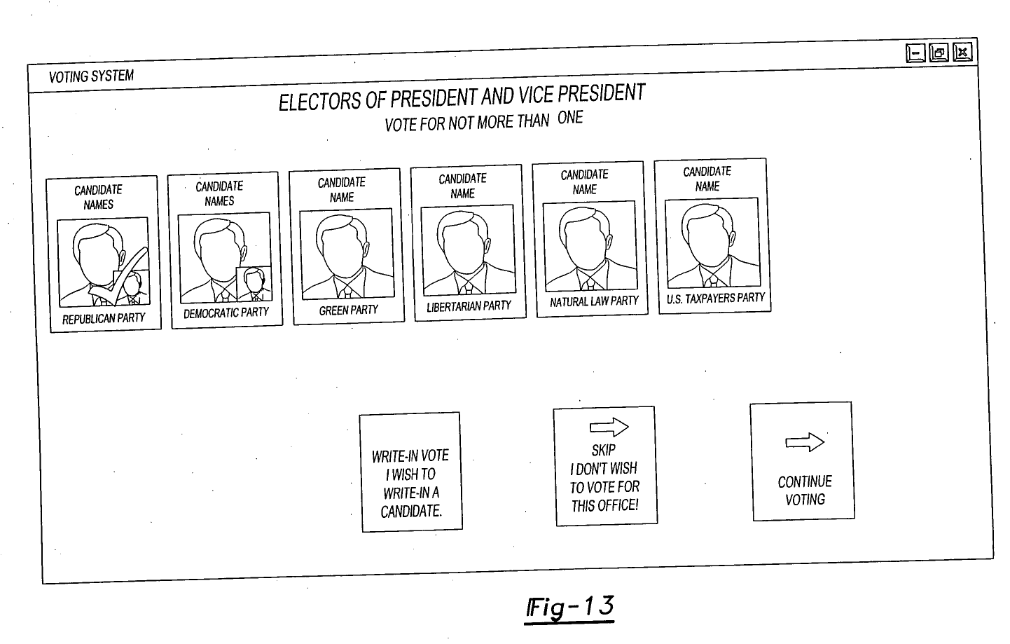

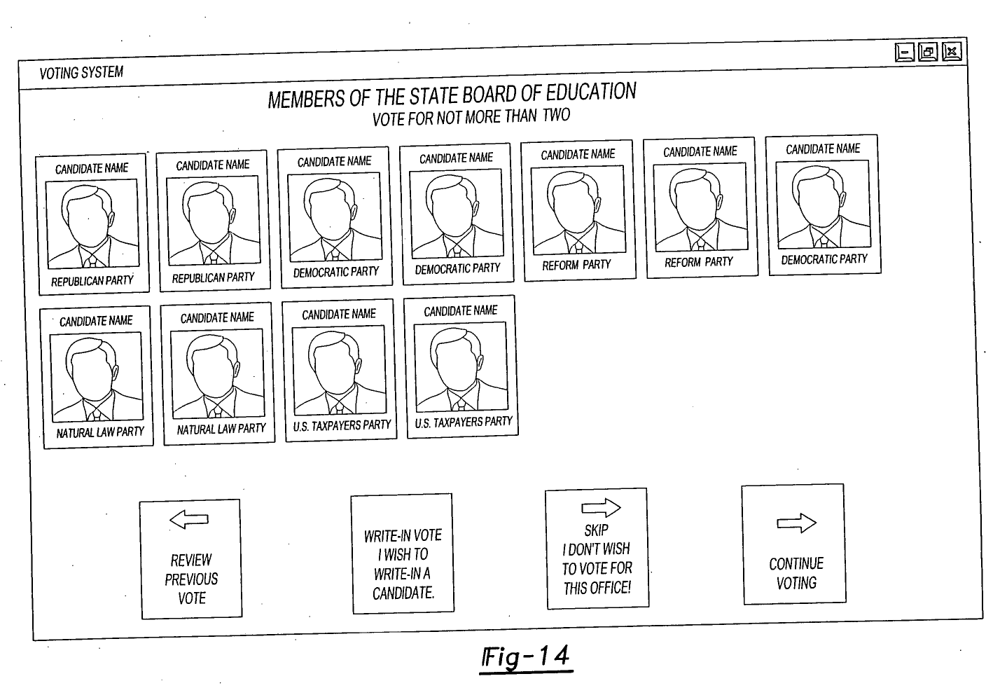

In step 47, an enlarged display (e.g., between one-quarter screen and full screen as shown in FIG. 12) of the selected candidate is presented to the voter along with a confirmation selection item (e.g., the “yes” button in FIG. 12) and a cancel selection item (e.g., the “no” button in FIG. 12). Step 48 waits for the voter to select one of the buttons, and if the candidate selection is cancelled then a return is made to step 45 to re-display the slate of candidates. If the candidate selection is confirmed, then a check is made in step 50 to determine whether more candidates from the slate can be selected (i.e., the election contest is for multiple seats). If more candidates can be selected, then a return is made to step 45 wherein the slate of candidates is redisplayed with an indication of the candidate(s) already selected (e.g., highlighting or shading of a deactivated selection item block for the already chosen candidate).

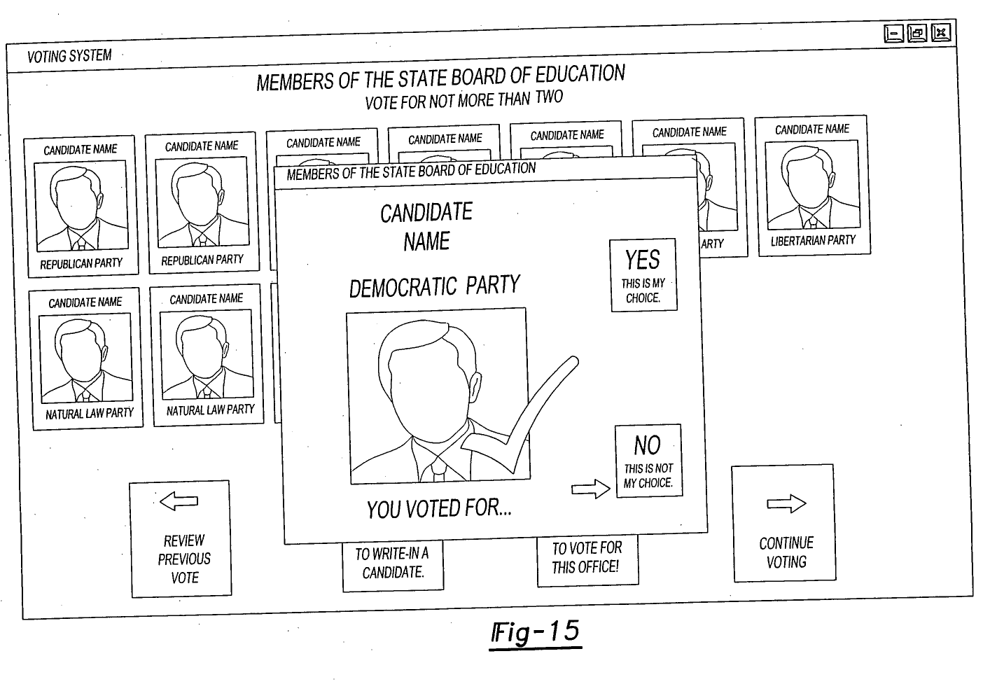

If no more candidates can be selected (or if the voter skips any further selections), then a check is made in step 51 to determine whether there are additional partisan election contests to be voted. If so, then a return is made to step 43 to fetch the next contest. FIG. 14 demonstrates a slate for further partisan contests for which votes can be cast for only one candidate. FIG. 15 shows an enlarged display for confirming a vote for one of the candidates on this slate.

If there are no further partisan contests, then a summary screen may be presented to the voter in step 52 to allow review and/or changes to the votes cast. Alternatively, the method may proceed directly to any nonpartisan contests at point B and any review or changes can be done once after all votes have been cast on the entire ballot.

Voting for nonpartisan contests begins at point B in FIG. 4. The first nonpartisan contest is fetched in step 53. A slate of candidates for the nonpartisan contest is displayed in step 54. In step 55, the voter selects a candidate by touching the selection item block containing the candidate's name, picture, and party of their choice. In step 56, an enlarged display of the selected candidate is presented to the voter along with a “yes” button and a “no” button. If the selection is not confirmed in step 57, then a return is made to step 54 to re-display the slate of candidates. If the candidate selection is confirmed, then a check is made in step 58 to determine whether more candidates from the slate can be selected. If more candidates can be selected, then a return is made to step 54 wherein the slate of candidates is re-displayed with an indication of the candidate(s) already selected.

After no more candidates can be selected (or if the voter skips any further selections), then a check is made in step 60 to determine whether there are additional nonpartisan election contests to be voted. If so, then a return is made to step 53 to fetch the next contest. Otherwise, a summary/change screen may be presented to the voter in step 61.

Thereafter, the method proceeds to voting on any proposals (i.e., ballot initiatives) included in the election contests that are decided by yes or no votes. In step 62, a first proposal is fetched. In step 63, the approved text of the proposal is displayed on the touch screen monitor. An optional font size can be selected so that the text can be enlarged to any extent necessary to allow it to be read by voters with poor visual acuity. The voter selects a yes vote, a no vote, or skips voting on the proposal in step 64. An enlarged display of the desired selection is shown in step 65 along with confirmation and cancel buttons. If not confirmed, then the text of the proposal is re-displayed in step 63. Otherwise, a check is made in step 67 to determine whether there are additional proposals to be voted on. If there are more, then a return is made to step 62 to fetch the next proposal. If there are no more proposals, then voting selections are finished. FIG. 17 shows a screen that is displayed to inform the voter that their ballot is completed and that their selections can be reviewed prior to printing and submitting their votes.

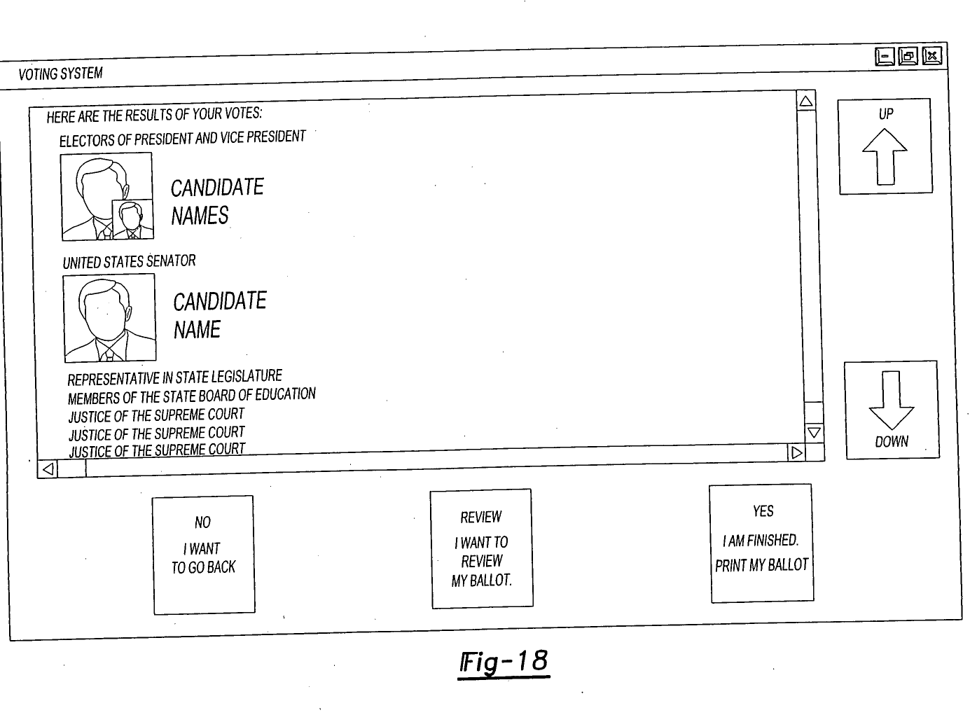

Unless the voter chooses not to review any selections, a summary and change screen is presented in step 68. FIG. 18 shows a summary pop-up window overlying the screen of FIG. 17. The summary window shows each election contest and any selections that have been made by the voter. If the voter has selected the wrong candidate, in error, he touches the NO name to go to the beginning of the process, then touches SKIP until he reaches the vote he wants to change. When a new selection is made and confirmed, the method returns to the summary window of FIG. 18.

After the voter has completed any review, they touch a selection item to indicate that they are finished and that they wish to print their ballot. A hardcopy of the ballot is printed in step 70. In an embodiment wherein the votes cast are tabulated electronically directly from the voting stations, the votes cast are transmitted to a server databank in step 71 concurrently with printing the hardcopy. The hardcopy ballot is submitted to a ballot box in step 72 (e.g., for purposes of a recount or as an original ballot for an official vote count if desired). Preferably, the hardcopy ballot may be retrieved by the voter from the printer and delivered personally to a ballot box, thereby increasing the confidence level of many voters in the integrity of the voting system since they experience something physically tangible showing their votes. Once the voter leaves the voting station, the display reverts to the wait screen of FIG. 5.

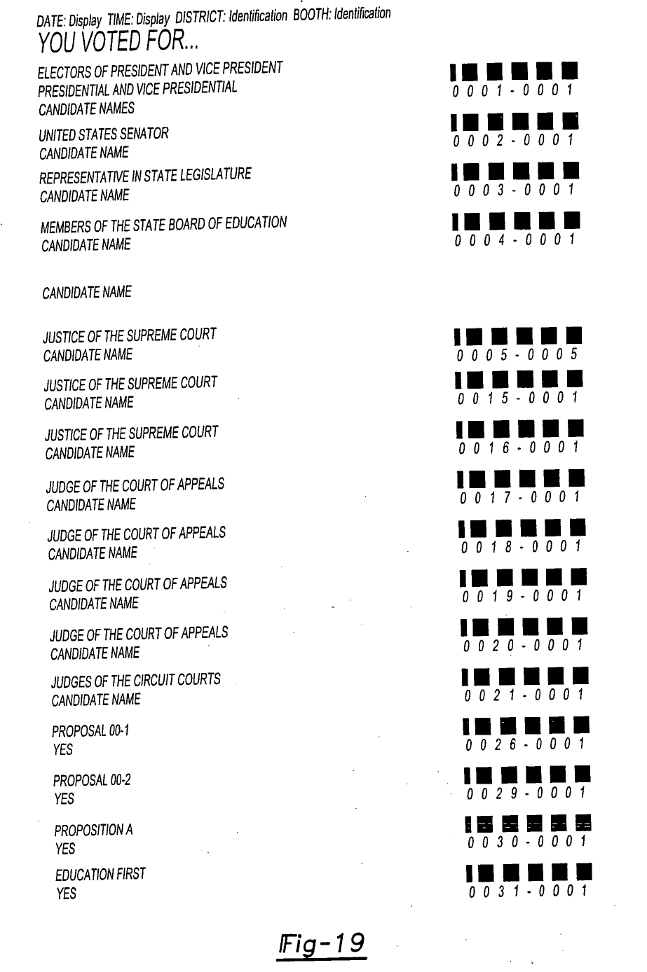

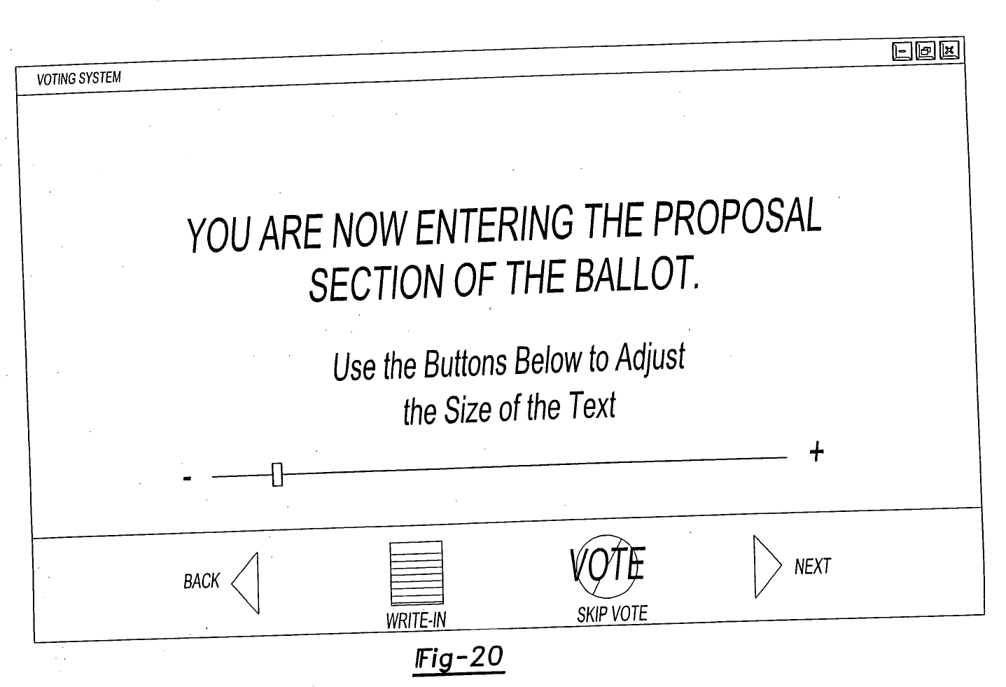

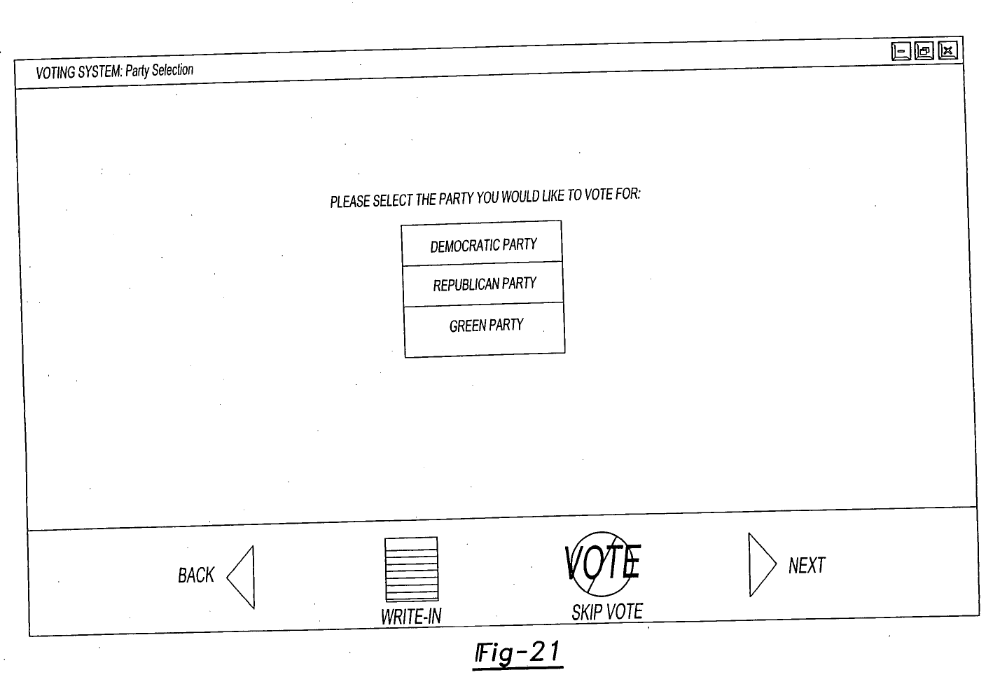

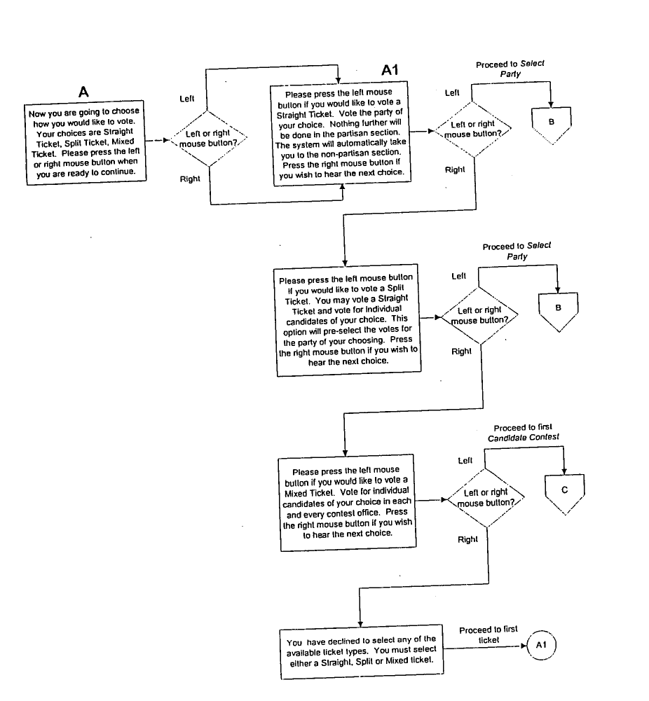

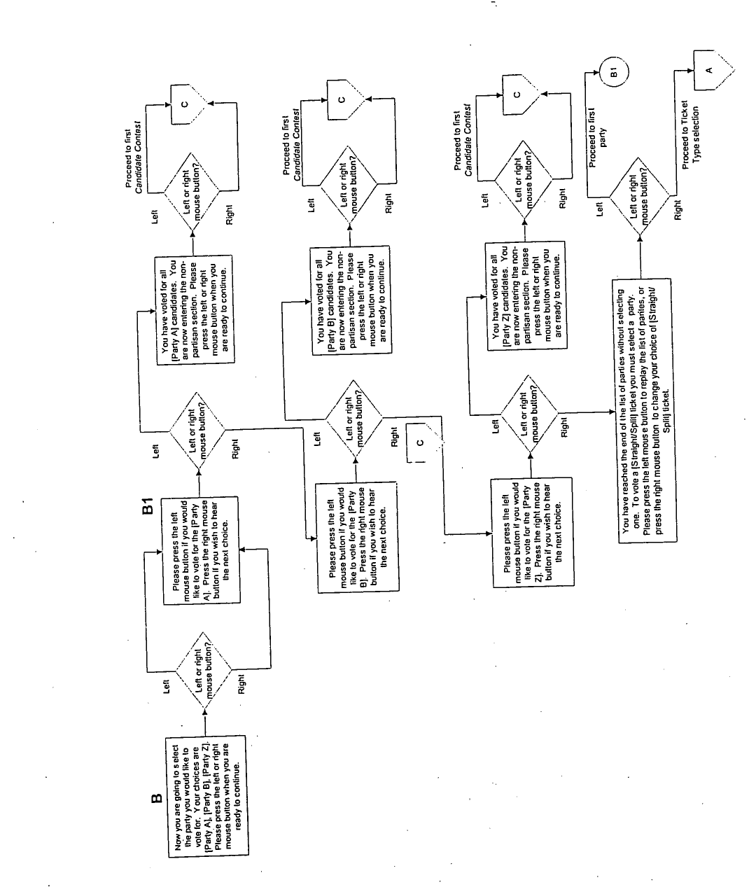

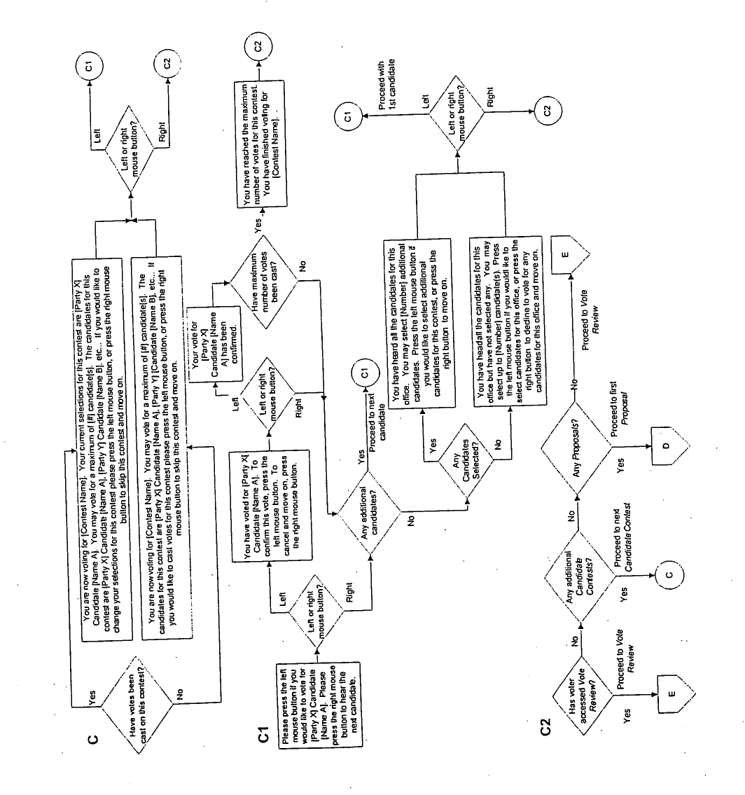

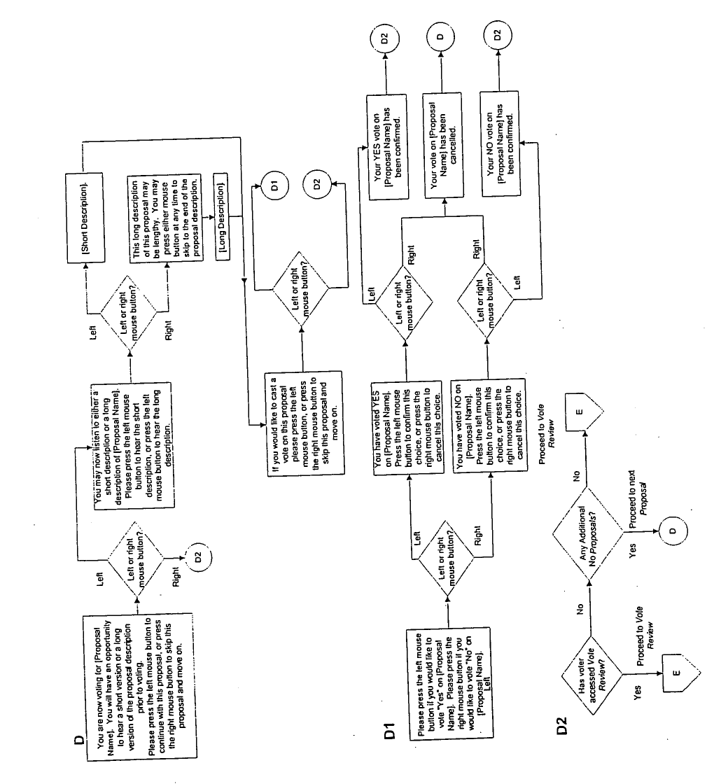

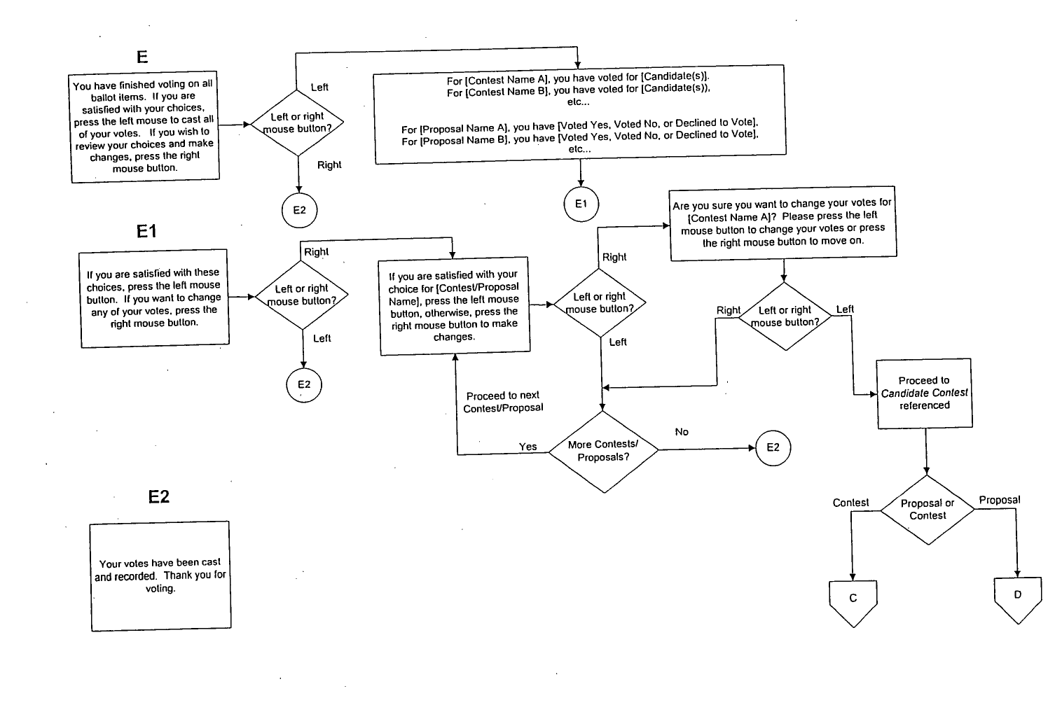

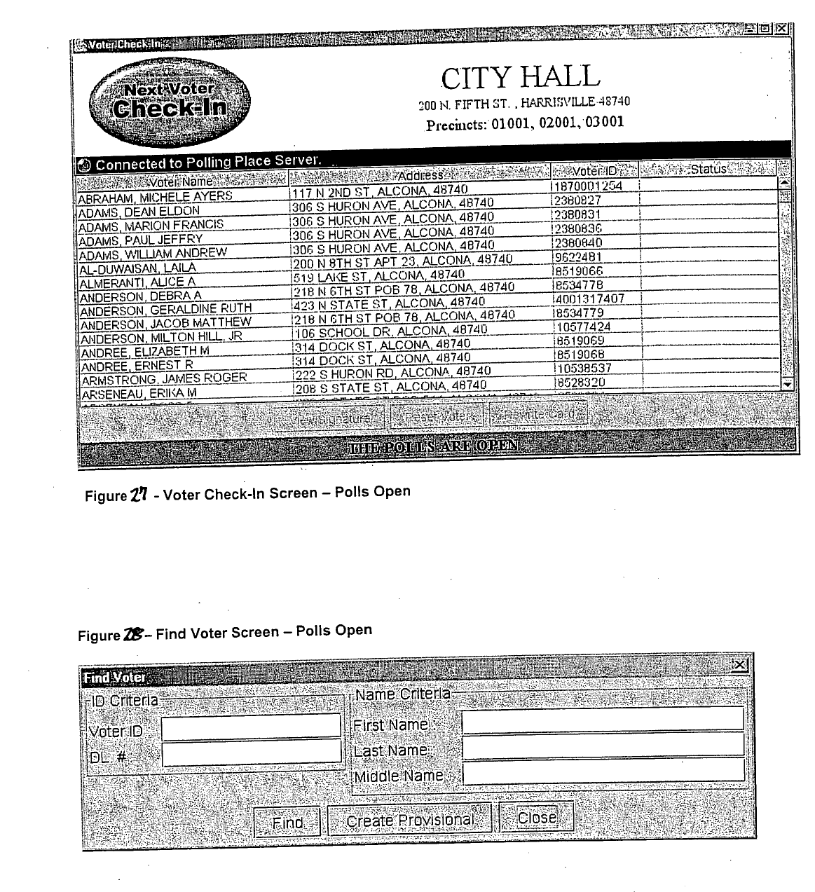

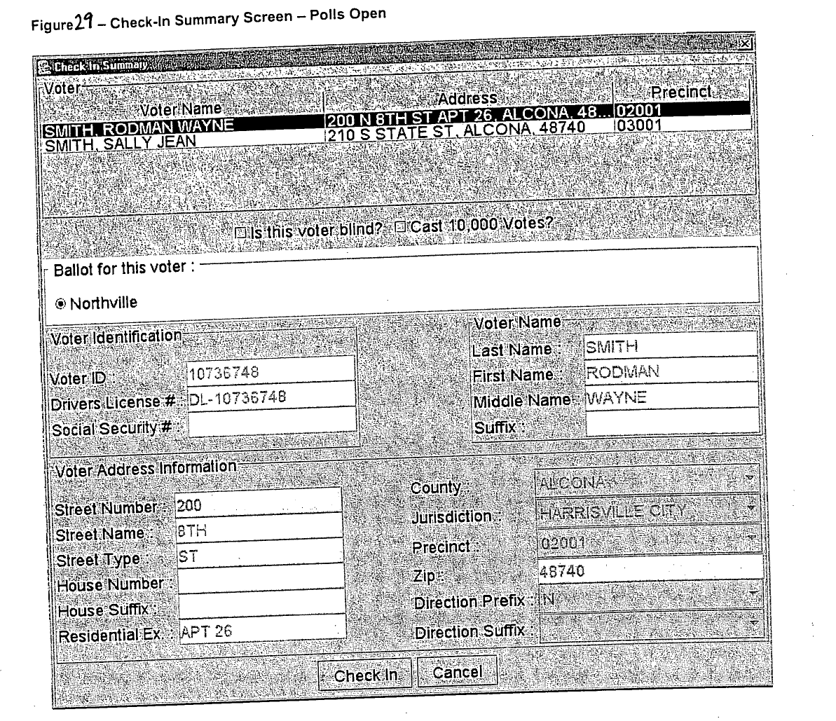

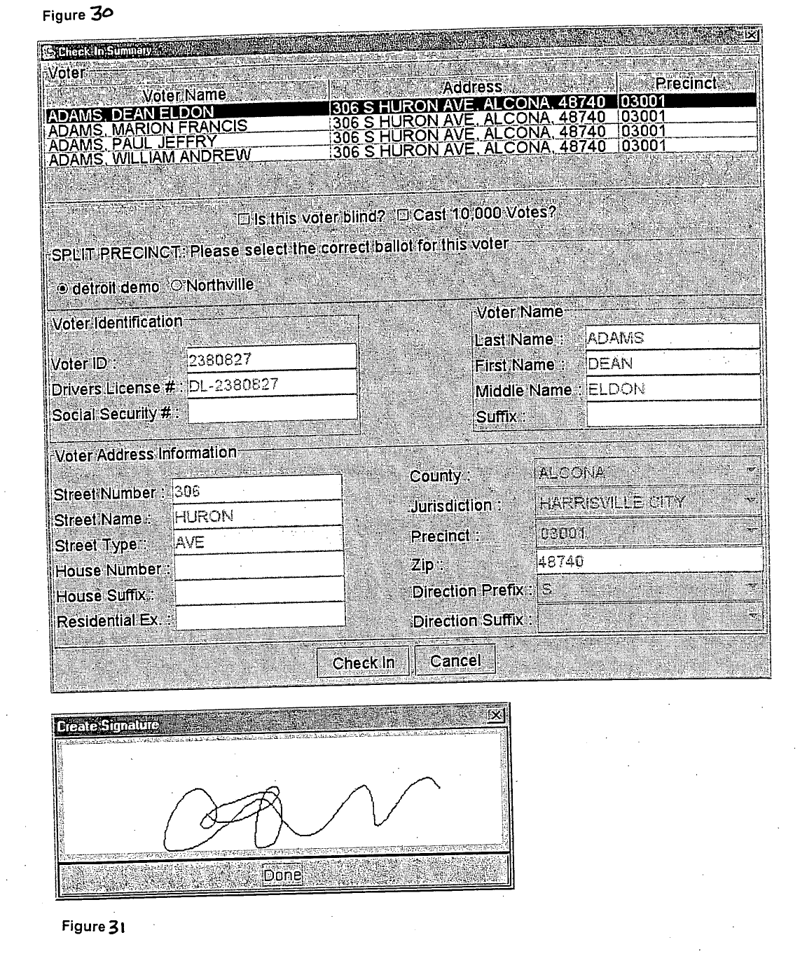

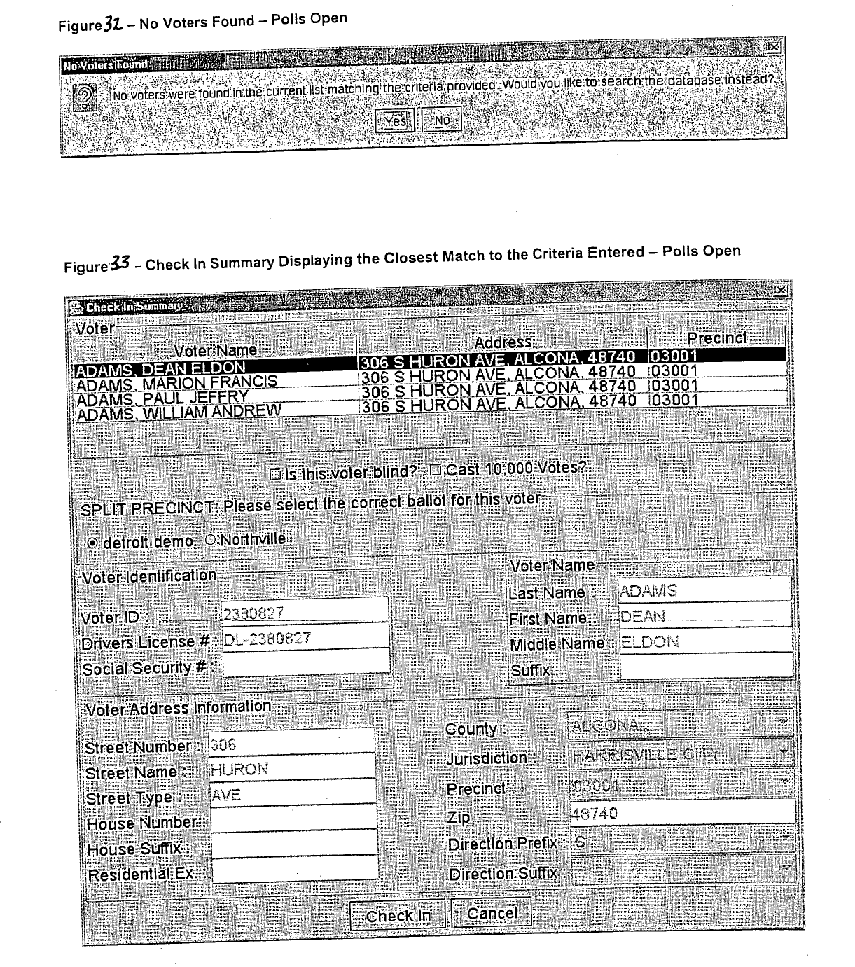

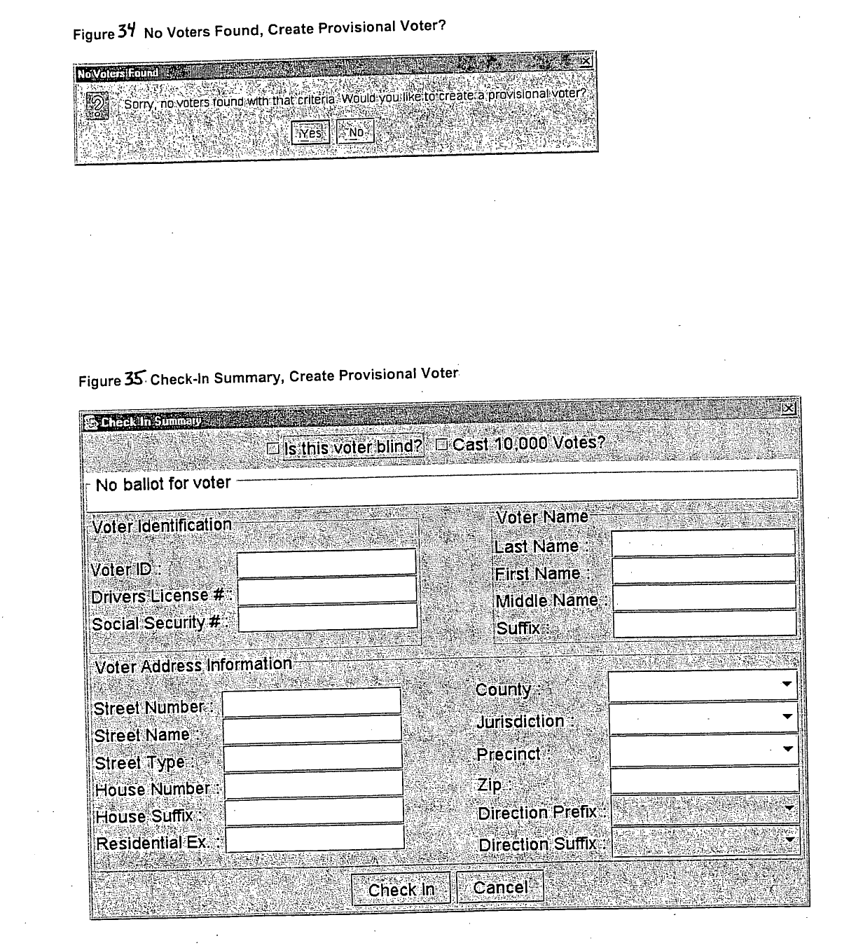

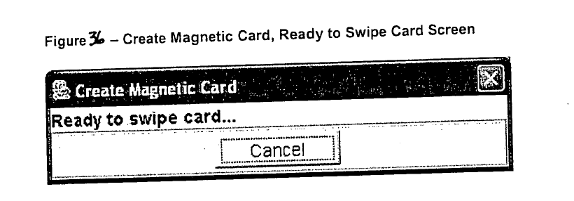

To improve counting and handling of hardcopy ballots, each election contest and selected candidate or other result of a vote may preferably be printed on the hardcopy ballots by means of a barcode or other electronically scannable symbols. A sample hardcopy ballot is shown in FIG. 19.

In a stiff further embodiment, an electronic voting system, as disclosed in U.S. patent application Ser. No. 10/120,221, further includes a text size selection feature, as illustrated in FIG. 20. The text size selection feature enables the user to adjust the size of the text to suit his or her comfort. The text selection feature includes sample text, an increase size indicator, a decrease size indicator, and a slide bar. The sample text appears in a predetermined font size, as shown by way of example in FIG. 20. Actuation may be accomplished by known means, for example, by mouse, touch screen, or stylus. To decrease the size of the sample text, the user actuates the decrease size indicator. The decrease size indicator appears in FIG. 20 by way of example as the symbol “−.” For each user actuation of the decrease size indicator, the font size of the sample text will correspondingly decrease. Similarly, to increase the font size of the sample text, the user actuates the increase size indicator. The increase size indicator appears in FIG. 20 by way of example as the symbol “+.” For each user actuation of the increase size indicator, the font size of the sample text will correspondingly increase. Alternatively, to adjust the size of the sample text, the user can manipulate the slide bar, depicted by way of example as a white rectangle in FIG. 20. Moving the slide bar in a first direction will decrease the font size of the sample text, while moving the slide bar in a second direction will increase the font size of the sample text. Once the user indicates that he or she is satisfied with the selected font size of the sample text, the same or substantially similar font size will be used in the remainder of the voting process.

In a yet still further embodiment, an electronic voting system, as disclosed in U.S. patent application Ser. No. 10/120,221, further includes a flashing selection indicator feature, as illustrated in FIG. 21. A selection bar is included on a portion of most screens viewed by the voter in the voting process. The exemplary selection bar illustrated in FIG. 21 includes several user selections, including, but not limited to, “BACK,” “WRITE IN,” “SKIP VOTE,” and “NEXT.” The user selections within the selection bar that are valid actions for a given screen in the voting process will change in appearance so as to draw attention thereto, for example by flash. In the alternative, only a predetermined default selection within the selection bar, such as but not limited to “NEXT” will flash, indicating to the user that actuating the flashing selection will cause the next screen in the voting process to be displayed.

According to other embodiments, the voting system of FIG. 1 may be utilized in an audio mode that provides the voter with audio prompts and receives voter selections made in response to those audio prompts. The voter selection is made by a non-visual means that does not require sight. According to one embodiment, the system is adapted to receive voter responses to audio prompts from a non-visual means of voter input such as by a mouse 12a. According to one embodiment, at least one set of headphones 17 or other private listening means is provided at each voting station and the voter receives audio prompts through the private listening means.

The audio mode embodiments provided herein are suitable for use by a visually impaired voter such as a voter who is blind or who has low vision. In addition, the audio mode would be suitable for use by a voter who cannot read or has difficulty reading. According to one embodiment, the audio mode information may be provided to at least one additional person, such as a polling place worker, engaged to assist the voter.

According to one embodiment, the voting system of FIG. 1 may be utilized in an audio mode that provides the voter with audio prompts and additionally provides text and pictorial displays on the display monitor 12, each display on the display monitor 12 corresponds to an audio prompt or to a voter selection made in response to an audio prompt. According to one embodiment, the system is adapted to receive voter responses to audio prompts from a non-visual means of voter input such as by a mouse 12a. The audio prompt instructs the voter to input the response via right or left mouse 12a click in accordance with the corresponding result desired by the voter. This provides for a low cost system in that special hardware is not required to enable the voter to enter a response to an audio prompt. According to one embodiment, at least one set of headphones 17 or other private listening means is provided at each voting station and the voter receives audio prompts through the private listening means. According to one embodiment, a keyboard may additionally be attached to the voting system, and is activated for use only when an a “write-in” response is desired. Only the necessary keys are activated to improve accuracy of the response. According to one embodiment, the keyboard includes Braille characters.

If the display monitor 12 is also a touch screen, the touch screen is placed in an inoperable mode so that it serves only as a display monitor for text and pictures corresponding to the audio prompts and the responses to the audio prompts. The corresponding visual display may additionally be adjustable by the voter by a non-visual means while the system is in audio mode.

The audio mode with corresponding text and pictorial display is suitable for use by a visually impaired voter such as a voter who is blind or who has low vision. In addition, the audio mode would be suitable for use by a voter who cannot read or has difficulty reading. According to one embodiment, the audio mode with text and pictorial display may provide information to at least one additional person, such as a polling place worker, engaged to assist the voter.

The audio mode may be provided in any one language of a variety of languages. According to one embodiment, the voter selects audio mode or someone assists the voter in selecting audio mode. The voter then receives an audio prompt to choose a language. All information transmitted to the voter from the voter interface is provided to the voter selected language. According to one embodiment, an audio prompt asks the voter whether he or she would like audible instructions or overview of an audible demonstration before voting begins. According to one embodiment, the audio portion and text portion of the voter interface having the corresponding pictorial and text display are provided in a voter selected language in response to an audio prompt to select a language.

According to one embodiment, the voting system prompts the voter to make only one of two choices at each step in the voting process, such as a choice to proceed or not to proceed, a choice between choosing an option or receiving additional options, a choice to confirm choices or not confirm choices, or a choice to provide a “write-in” response or not. This simplifies each step of the voting process to a simple easy to answer question.

As will be understood by one of ordinary skill in the art, each voting system will be customized to a given election.

Exemplary embodiments are provided herein in FIG. 22-FIG. 26 for a set of programmed audio instructions guiding a voter through the voting process.

FIG. 22 illustrates an embodiment of a flow chart for the voting system of the present invention in audio mode. According to one embodiment, the audio mode provides the voter with an audio list of options regarding the possible formats for the election. According to one embodiment, the possible format options include, but are not limited to: “straight ticket”, “split ticket”, and “mixed ticket”. This notifies the voter of the upcoming format choices and prompts the voter to indicate when he or she is ready to continue. The system checks for the voter's response and if the voter has indicated that he or she is ready to continue, the system proceeds with a series of audio prompts, each related to a particular format option that was previously listed. The system checks for the voters response to each format option, and if the voter does not select any format, the voter again receives a series of audio prompts each related to one of the possible format options. Once the voter has chosen a format, the system proceeds to a corresponding next step.

FIG. 23 illustrates an embodiment of a flow chart for the voting system of the present invention in audio mode. According to one embodiment, the audio mode provides the voter with an audio list of options regarding the political parties participating in the election. This notifies the voter of the upcoming party choices and prompts the voter to indicate when he or she is ready to continue. The system checks for the voter's response and if the voter has indicated that he or she is ready to continue, the system proceeds with a series of audio prompts, each related to a particular political party that was previously listed. The system checks for the voter's response to each party option, and if the voter does not select any party, the voter again receives a series of audio prompts each related to one of the possible party options or prompts the voter to change the format selection. Once the voter has chosen a party or has chosen mixed format, the system proceeds to the next step.

FIG. 24 illustrates an embodiment of a flow chart for the voting system of the present invention in audio mode. According to one embodiment, the system recognizes whether the voter has chosen a party in the straight ticket or split ticket format or whether the voter has chosen the mixed ticket option in previous steps.

If the voter selected a party, the system notifies the voter of each individual contest, the voter's selection of party and candidate for that contest, and provides a prompt allowing the voter to alter the selection for the individual contest. If the voter wishes to alter the selection, the system provides a series of audio prompts each related to one of the possible candidates and the candidate's corresponding political party or the option to confirm or cancel the selection. The system also provides additional audio prompts relating to the additional number of candidates that may be chosen for a particular contest, the remaining available candidates and corresponding parties, and any further non-partisan contests. If the voter has mad no selections, the system prompts the voter to proceed with candidate selection or decline to vote. If the voter indicates no additional changes and if there are no proposals to be voted on, the system proceeds to audio review of the voter's selections. If there are proposals to be voted on, the system proceeds to audio prompts related to the proposals.

If the voter previously chose the mixed ticket format, the system provides the voter with audio information regarding each separate contest, candidate and corresponding party and allows the voter to select at least one or skip that contest. the system provides a series of audio prompts each related to one of the possible candidates and the candidate's corresponding political party or the option to confirm or cancel the selection. The system also provides additional audio prompts relating to the additional number of candidates that may be chosen for a particular contest, the remaining available candidates and corresponding parties, and any further non-partisan contests. If the voter has mad no selections, the system prompts the voter to proceed with candidate selection or decline to vote. If the voter indicates no more changes and if there are no proposals to be voted on, the system proceeds to audio review of the voter's selections. If there are proposals to be voted on, the system proceeds to audio prompts related to the proposals.

FIG. 25 illustrates an embodiment of a flow chart for the voting system of the present invention in audio mode. According to one embodiment, the system provides the voter with audio prompts related to proposals to be voted on. The system provides an audio prompt for the short or long version of a proposal, an audio prompt to skip to the end of at least some proposals, and an audio prompt to vote or skip the proposal. If voting on a proposal, the voter is prompted for a yes or no response and is prompted to confirm or cancel the selection. If canceled, the process repeats. Once the system receives the voter's confirmation, the system provides an audio prompt for the next proposal until all voter responses complete. If no more proposals remain to be voted on, the voter then receives an audio prompt for audio vote review.

The flow chart in FIG. 26 illustrates an embodiment of the audio mode of the inventive voting system. According to one embodiment, the system prompts the voter to either confirm all selections made or to review the selections. If after review the voter wishes to make changes, the individual selections are reviewed and the voter is prompted to confirm that changes are desired. If the voter confirms that changes are desired, the system returns to the audio prompts related to the contest or proposal the voter would like to change.

According to one embodiment, the visual mode and the audio mode with corresponding pictorial and textual display, of the present invention can be unified to utilize the same set and sequence of screen displays.

The present invention includes computer readable storage media encoded with software for carrying out the voter interface embodiments and voting system operations described herein.

According to one embodiment, a user selection means is provided to receive user input. According to various embodiments the user selection means may be a keyboard, a mouse or a Braille keyboard. According to one embodiment, all input features are activated for the user selection means.

According to one embodiment, a plurality of audio prompts are provided in which each audio prompt asks the voter to choose between two possible options at each step in a voting process. A user selection means is provided to receive the voter's response to the prompt asking the voter to choose only one of two possible responses. According to one embodiment, the user selection means recognizes only two input options, the voter provides his or her response by executing one of the two input options. Thus, the input option selected by the voter corresponds to the voter's choice of one of two possible responses. For example, the user selection means may be a device having only two buttons, one button represents one of the two possible choices and the other button represents the other of the two possible options. The user executes his or her response through contact with the button corresponding to the voter's preference. The user selection means may be a device having only two activated buttons. One button represents one of the two possible choices and the other button represents the other of the two possible options. The user executes his or her response through contact with the button corresponding to the voter's preference. The user selection device may have a single button for which contacting the button once indicates one of two possible responses and contacting the button twice indicates the other of the two possible responses. The user selection device may be a sound recognition system recognizing two possible verbal responses by the voter. The voter executes their selection by verbally stating the response corresponding to their preference. The user selection device may be a breath activated device that recognizes the input of one breath or two breathes. The voter executes his or her response by exhaling a single breath or exhaling two breaths. Once the voter selection is made in response to the prompt to select one of two choices, another prompt may follow allowing the voter to select between another set of two choices. The voter may respond in a like manner using the user selection means. This approach of prompting the voter to choose between two possible responses reduces voter error during the voting process. The provision of a user selection means recognizing two possible inputs assists in reducing voter error during the voting process.

According to one embodiment, a voter check-in system confirms voter eligibility to vote and generates a card that activates the polling station where the voter votes and displays a ballot specific to a particular voter. As part of the process of confirming voter eligibility, the voter check-in system uploads a qualified voter list stored on a polling place server via a secure local area network (LAN). When a potential voter arrives at the polling place, a poll worker identifies the voter.

According to one aspect of the invention, the voter is identified by swiping an existing state identification card, or by swiping a state driver's license at voter check-in. According to one embodiment, the voter is identified through presentation of a voter registration card having the voters identification number that was assigned when the voter registered to vote, the voter identification number specific to that voter is input into the check-in system. According to one embodiment, voter specific criterion other than the voter registration number is input and a search matching the input information to the qualified voter list stored on the polling place server displays at least one possible match. If no match can be identified, the system accepts input corresponding to a provisional voter.

Once a voter match is selected or provisional voter input is completed, a transportable medium is generated. The transportable medium is then used at the polling station where the voter votes to retrieve the ballot appropriate for the particular voter. According to one embodiment, the transportable medium is a card. The card is then used at the polling station where the voter votes, to retrieve the ballot appropriate for that voter.

According to one embodiment, when a voter match is selected, the voter may input information to finally verify the selection. According to one option, a digital signature option may be presented to the voter for verifying the proper choice of voter information. The voter may provide a signature that is stored digitally.

According to one embodiment, a biometric measurement of the voter may be made and recorded. The measurement may be used to search for the voter in a voter eligible list or database in order to identify the voter. Such a measurement may also be recorded as an indication by the voter verifying the proper selection of voter information.

FIG. 27 illustrates an embodiment of a screen in a voter check-in system. Selection of the next voter check-in button results in the display of a search screen that can be used in searching for a voter.

FIG. 28 is an illustration of a Find Voter Screen. According to one embodiment, a search screen may be presented that can be used in searching for a voter. Data provided by the voter is entered into the screen. Such data may be the voter's identification number which is assigned by a government body when the voter registers to vote, the voter's state identification number, the voter's driver's license number, the voter's name, or the voter's social security number. Other voter specific information may be used which will correspond to stored qualified voter information. A system conducts a search. If the criterion entered matches an entry in the qualified voter list that match will be displayed. Once the proper voter information is displayed, a selection may be made, if appropriate, to indicate that the voter is visually impaired. According to one embodiment, the search screen may take the form of the screen in FIG. 28.

FIG. 29 is an illustration of a Check-In Search Summary Screen. According to one embodiment, a search summary screen may be presented in which the search result matching information in the stored qualified voter list is displayed. Additional voter information may be displayed to assist in verifying the match. If the match is initially verified, the voter may be selected. Once the proper voter information is displayed, a selection may be made, if appropriate, to indicate that the voter is visually impaired. According to one embodiment the search summary screen takes the form of the screen in FIG. 29. The check-in button may be selected to select the highlighted voter.

FIG. 32 illustrates an embodiment of a No Voters Found Screen. According to one embodiment a screen may be presented to indicate that no voters were found to match the criteria or criterion in put. If no voters were found in the qualified voter list to match the criterion provided, a database search may be performed. According to one embodiment, the screen indicating that no voters were found may take the form of the No Voter's Found Screen of FIG. 32. The screen may prompt the user to indicate whether a database search is desired. The screen may provide for a yes or no response. If the selection is yes, then a data base search is conducted based upon the input criterion.

FIG. 33 illustrates the Check-In Summary Displaying the Closest Match to the Criteria Entered Screen. According to one embodiment, a screen may be presented to display the closest matches to the input criterion, each possible match may be highlighted and additional voter information may be displayed to assist in verifying the proper match. According to one embodiment, the screen presenting the closest matches may take the form of FIG. 33. The proper match may be highlighted. Once the proper voter information is displayed, a selection may be made according to one embodiment to indicate that the voter is visually impaired. Once the proper selections are made for a voter, the check-in button may be selected.

FIG. 34 illustrates a No Voters Found, Create Provisional Voter Screen. According to one embodiment, if no matches correspond to the criterion entered, a screen may be presented to indicate that no voters were found to match the input criterion. According to one embodiment, if not matches correspond to the criterion entered and the database search, a screen may be presented to indicate that no voters were found to match in the database search. According to one embodiment, the screen may take the form of the No Voters Found, Create Provisional Voter Screen of FIG. 34. The screen provides for a yes or no response.

FIG. 35 illustrates an embodiment of a Create Provisional Voter Screen. According to one embodiment, a screen may be display for entry of data to define a provisional voter. The screen may allow for entry of information including but not limited to: voter identification number, drivers license number, social security number, voter name, voter address information. According to one embodiment, the screen for entry of data to define a provisional voter may take the form of the screen in FIG. 35.

FIG. 29 illustrates an embodiment in which a ballot is automatically associated with the highlighted voter.

FIGS. 30 and 33 illustrate an embodiment in which a list of ballots are displayed. A selection of the appropriate ballot or ballots may be made.

FIG. 35 illustrates an embodiment in which one or more precincts are represented at a polling place. According to one embodiment a voter check-in screen listing voter information allows selection of the proper ballot for the voter. For a provisional voter, this field may remain blank until Country, Jurisdiction and Precinct have been specified, after which the screen is populated with the appropriate ballot or ballots.

FIG. 31 illustrates an embodiment of presentation of a digital signature option. A voter may provide a signature that is stored digitally to verify a selection. According to one embodiment, a digital signature option is provided in response to highlighting of the proper voter information and selection of the check-in button as described with respect to FIG. 29. According to one embodiment, a digital signature option is provided in response to highlighting of the proper voter information and selection of the check-in button as described with respect to FIG. 30. According to one embodiment, a digital signature option is provided in response to highlighting of the proper voter information and selection of the check-in button as described with respect to FIG. 33. According to one embodiment, a digital signature option is provided in response to selection of the check-in button as described with respect to FIG. 35 after the provisional voter information is sufficiently populated and a ballot option has been made available and has been selected.

According to one embodiment, a biometric measurement such as a fingerprint may be used to verify the voter. The fingerprint information may be used at check-in to match the voter fingerprint to voter information in a searchable database. One advantage of such a procedure is that it can be used to verify the voter where traditional voter information such as voter state identification number, driver's license, voter registration identification number, name or address are not available or are not necessarily determinative of a voter's identity. The fingerprint information may be stored digitally. According to one embodiment, the voter may sign electronically after the voter's fingerprint information is used to retrieve voter specific information to verify that the information retrieved is accurate.

According to one embodiment, a voter may provide a fingerprint to verify the proper identification of the voter at voter check-in. The fingerprint information may be stored digitally. According to one embodiment, the fingerprint information obtained from a voter at voter check-in may be used to verify the proper selection of retrieved voter information and selections with respect to whether the voter is visually impaired and the proper ballot selection for the voter.

A ballot may be matched to a voter based upon voter specific information. According to one embodiment, a ballot is matched to a voter based upon County, Jurisdiction and Precinct information corresponding to that voter. There may be proposals to be voted on by certain voters, for instance a proposal may apply only to voters of a particular street. The voter specific ballot will contain the candidate options and proposal options available to that particular voter.

A transportable medium may be generated at voter check-in that contains information that may be used at the polling station where the voter votes to provide the voter with the screen ballot corresponding to that voter. According to various embodiments, the transportable medium may contain voter specific information, ballot specific information or a unique number or digital information generated for use in retrieving the ballot for the particular voter. According to one embodiment, the transportable medium may be a card generated with voter specific information stored thereon. The voter specific information may include party affiliation. According to one embodiment, the transportable medium may be a card generated with ballot specific information corresponding to the particular voter stored thereon. According to one embodiment, the transportable medium may be a card generated to store a randomly generated number or digital information for use in retrieving the ballot for the particular voter.

According to one embodiment, the transportable medium may be a magnetic card containing information that may be used at the polling station to provide the voter with the screen ballot corresponding to that voter. The magnetic card may be read at the polling station, and the polling station may then retrieve the correct ballot for that particular voter. The information retrieved from the card may be used in retrieving the ballot corresponding the particular voter. According to one embodiment, the polling station may retrieve the ballot from the polling place server and present the ballot to the voter. The selected voter information can be compared to stored information of which voters have already voted, if it is determined that a voter has already voted, no ballot will be generated.

According to one embodiment, a poll worker may assist an individual who is visually impaired with retrieval of the ballot. According to one embodiment the worker can swipe a magnetic card at the polling station in a magnetic card reader at the polling station in order to retrieve the ballot for the visually impaired voter, and assist the voter with headphones and location of a user selection means. The display of the ballot at the voting station includes providing audio prompts corresponding to the matched ballot, the audio prompts are suitable for a visually impaired voter as described herein allowing the voter to make selections by non-visual means.

The voter can then respond to audio prompts to make selections, including but not limited to selection of language. According to one embodiment, the audio mode for the visually impaired may be activated by information generated and stored on the transportable medium.

FIG. 36 illustrates an embodiment of a Magnetic Card Screen. According to one embodiment, a screen is displayed at voter check-in to indicate that a card may be swiped at the polling station in a magnetic card reader located at the polling station in order to retrieve the ballot information. According to one embodiment a screen is displayed at the polling station to indicate that a card may be swiped at the polling station.

According to one embodiment, the voting system may access information of qualified voters and ballots on a regional level that reaches beyond a particular precinct and identifies the ballot appropriate for that voter. This allows for a voter to be identified at a precinct's check-in even when outside of their voting district. A precinct would be able to retrieve the ballot for that particular voter and allow the voter to vote at that location. According to one embodiment, the voting system may access qualified voter information for a particular county or for a region extending beyond one county. According to one embodiment, the voting system may access qualified voter information for an entire state or for a region extending beyond a single state. According to one embodiment, the qualified voter list may contain voters known to be eligible to vote on a country-wide basis. According to one embodiment, the regional data extending beyond a single precinct is stored in a qualified voter list. According to one embodiment, the regional data extending beyond a single precinct is stored in a searchable database.

According to one embodiment, data is stored containing voting data generated at a particular voting location. All data and communications can be maintained at a single location until voting is complete. Information required to be maintained such as which voters voted in a particular election, can be stored. Data reports can be automatically generated. Secrecy can be protected by allowing only certain information to be provided in a given report.

The embodiments of the present invention reduce the time for identifying voters at voter check-in. The embodiments of the present invention increase accuracy in identifying voters and in providing voters with appropriate ballots. Electronic matching of ballots to voters eases the burden on poll workers. This can result in more voting options being presented to smaller groups of voters, such as proposals applying to only a small group of voters without introducing complexity for poll workers. Voting records can be generated electronically and stored digitally in real time allowing for ease of recreation of data. Voting records can additionally be generated in hard copy. Both electronic data and hard copy data can be stored.

Many obvious modifications and adaptations of the foregoing embodiments will be apparent to those skilled in the art. Any such modifications or adaptations are intended to be covered by the appended claims. For example, certain elections may not include contests in all the categories of partisan contests, nonpartisan contests, and proposals, and the voting interface would be programmed to skip the corresponding sections of the foregoing method. In addition, the invention could be used with remote identification and verification (such as fingerprint ID as described above) to achieve Internet voting, for example.

1. A method for operating a voting station in an electronic voting system programmed for election contests, said voting station including a display screen for displaying textual and pictorial information and a user selection means for selecting preferences of a voter, said method comprising the steps of:
providing a visual mode; and
providing an audio mode including pictorial and textual displays on a display screen, each display on the display screen corresponding to an audio prompt or to a voter selection made in response to an audio prompt.

2. The method of claim 1 further comprising:
said voter manipulating a user selection means in response to the audio prompts.

3. The method of claim 1 further comprising:
providing a mouse for voter manipulation in response to the audio prompts.

4. The method of claim 3 further including:
audio prompts instructing the voter to input the response via right or left mouse click in accordance with the corresponding result desired by the voter.

5. The method of claim 1 further including:
providing private listening means for transmitting audio prompts to the voter.

6. The method of claim 1 further comprising:
providing headphones for transmitting audio prompts to the voter.

7. The method of claim 1 further comprising:
providing a keyboard for receiving voter input in response to the audio prompts.

8. The method of claim 1 further comprising:
providing a keyboard; and
activating the keyboard for use only when a “write-in” response is desired.

9. The method of claim 8 further comprising:
activating only the necessary keys to improve accuracy of the response.

10. The method of claim 1 further comprising:
providing a Braille keyboard for voter input in response to the audio prompts.

11. The method of claim 1 further comprising:
providing a Braille keyboard; and
activating the Braille keyboard for use only when a “write-in” response is desired.

12. The method of claim 11 further comprising:
activating only the necessary keys to improve accuracy of the response.

13. The method of claim 1 further comprising:
providing the display screen to include touch screen capability.

14. The method of claim 13 further comprising:
disabling the touch screen capability allowing only display on the display screen corresponding to the audio prompts and the responses to the audio prompts.

15. The method of claim 1 further comprising:
adjusting the visual display by non-visual means.

16. The method of claim 1 further comprising:
providing audio prompts and visual display to both a voter and at least one additional person engaged to assist the voter.

17. The method of claim 1 further comprising:
providing audio prompts in any one of a plurality of languages.

18. The method of claim 1 further comprising:
said voter selecting audio mode.

19. The method of claim 18 further comprising:
providing an audio prompt to the voter to select a language for the audio mode.

20. The method of claim 1 further comprising:
a person assisting the voter in selecting audio mode.

21. The method of claim 19 further comprising:
providing an audio prompt to the voter to select a language for the audio mode.

22. The method of claim 1 further comprising:
providing an audio prompt asking the voter whether he or she would like an audible demonstration before voting begins.

23. The method of claim 17 further comprising:
providing the audio portion and text portion of the voter interface, having the pictorial and text display corresponding to each audio prompt, in a voter selected language.

24. The method of claim 1 further comprising:
providing audio prompts asking the voter to make only one of two choices at each step in the voting process.

25. The method of claim 24 further including:
an audio prompt asking the voter to choose between proceeding or not proceeding.

26. The method of claim 24 further including:
an audio prompt asking the voter to choose between choosing an option or receiving additional options.

27. The method of claim 24 further including:
an audio prompt asking the voter to choose between confirm choices or not confirm choices.

28. The method of claim 24 further including:
an audio prompt asking the voter to provide a “write-in” response or not to provide a “write-in” response.

29. The method of claim 1 further comprising:
providing the voter with an audio list of options regarding the voting format.

30. The method of claim 29 further including:
providing the list to include the option to vote “straight ticket”.

31. The method of claim 29 further including:
providing the list to include the option to vote “split ticket”.

32. The method of claim 29 further including:
providing the list to include the option to vote “mixed ticket”.

33. The method of claim 29 further comprising:
checking for the voter's response to each format option.

34. The method of claim 33 further comprising:
providing a set of audio prompts corresponding the voting format chosen by the voter.

35. The method of claim 33 further comprising:
repeating the audio list of options regarding the voting format until the voter selects a format, if the voter does not select any format.

36. The method of claim 1 further comprising:
providing an audio prompt including a list of options regarding the political parties participating in the election.

37. The method of claim 36 further comprising:
allowing the voter to select a political party; and
checking for the voter's response.

38. The method of claim 37 further comprising:
repeating the list of options regarding the political parties participating in the election if the voter did not select a party; and
allowing the voter to select a party or change the format selection.

39. The method of claim 37 further comprising:
providing a series of audio prompts each related to a particular political party that was previously listed.

40. The method of claim 39 further including:
allowing the voter to select a party;
notifying the voter of each individual contest;
notifying the voter of the voter's selection of party and candidate for that contest; and
providing an audio prompt allowing the voter to alter the selection for the individual contest.

41. The method of claim 39 further comprising:
providing at least one audio prompt selected from the group of audio prompts consisting of: prompts relating to the additional number of candidates that may be chosen for a particular contest, the remaining available candidates and corresponding parties, and any further non-partisan contests.

42. The method of claim 39 further comprising:
checking for the voters selection;
instructing the voter to proceed with candidate selection or to decline to vote, if the voter has made no selections.

43. The method of claim 39 further comprising:
providing an audio review of the voter's selections.

44. The method of claim 43 further comprising:
providing audio prompts related to proposals to be voted on.

45. The method of claim 32 further comprising:
providing audio information regarding each separate contest in the mixed ticket;
providing each candidate and corresponding party, each additional candidate that may be chosen for a particular contest, and the remaining available candidates and corresponding parties;
providing any further non-partisan contests; and
allowing the voter to select at least one candidate or skip that contest.

46. The method of claim 45 further comprising:
checking for the voters response.

47. The method of claim 46 further comprising:
prompting the voter to proceed with candidate selection or to decline to vote if the voter has made not selections.

47. The method of claim 45 further comprising:
allowing the voter to make changes to the voter's selections.

48. The method of claim 47 further comprising:
providing an audio review of the voter's selections.

49. The method of claim 48 further comprising:
providing audio prompts related to proposals to be voted on.

50. The method of claim 1 including:
providing audio prompts related to proposals to be voted on.

51. The method of claim 50 including:
providing an audio prompt asking the voter to choose between a short or long version of the proposal.

52. The method of claim 51 including:
providing an audio prompt providing the option to skip to the end of at least some proposals.

53. The method of claim 51 including:
providing an audio prompt providing the option of voting or skipping to the end of the proposal.

54. The method of claim 51 further comprising:
providing an audio prompt providing the option of selecting a yes or no vote on a proposal; and
providing an audio prompt to confirm or cancel the selection.

55. The method of claim 54 further comprising:
providing an audio prompt for the next proposal if there are additional proposals to be voted on until all voter responses on the proposals to be voted on are complete.

56. The method of claim 55 further comprising:
providing an audio prompt providing the option of audio vote review.

58. The method of claim 1 further comprising:
providing an audio prompt to confirm all selections made or to review the selections.

59. The method of claim 58 further comprising:
providing an audio review of selections made;
allowing the voter to indicate that changes are desired;
providing an audio review of each selection and allowing the voter to indicate whether the selection is to be changed; and
returning to the audio prompts related to the contest or proposal the voter has selected to be changed.

60. The method of claim 1 further comprising:
the visual mode and the audio mode with corresponding pictorial and textual display unified to each utilize the same set and sequence of screen displays.

61. The method of claim 1 including:
operating the system in audio mode;
said display screen presenting a slate of candidates for an elected office, each of said candidates being displayed as a selection item including at least a textual name identifier and an image;
said voter manipulating said user selection means to select a desired on of said candidates;
said display screen presenting an enlarged representation of information corresponding to said desired candidate together with a confirmation selection item and a cancel selection item in response to the selection;
said voter manipulating said user selection means to select either said confirmation selection item or said cancel selection item;
if said cancel selection item is selected, then returning to presentation of said slate of candidates;
if said confirmation selection item is selected, then progressing through remaining election contests until said voter has confirmed a selection in each election contest;
said display screen presenting all voter selections on a review screen and presenting choices to said voter to change any of said selections;
said voter confirming no further changes; and
said voting station outputting said voter selections.

62. Software for carrying out a method of operating a voting station in an electronic voting system for election contests on a voting station including a display screen for displaying textual and pictorial information and a user selection means for selecting preferences of a voter, said software having a visual mode; and an audio mode including pictorial and textual displays on a display screen, each display on the display screen corresponding to an audio prompt or to a voter selection made in response to an audio prompt.

63. A computer readable storage media encoded with software for carrying out a method of operating a voting station in an electronic voting system for election contests on a voting station including a display screen for displaying textual and pictorial information and a user selection means for selecting preferences of a voter, said software having a visual mode; and an audio mode including pictorial and textual displays on a display screen, each display on the display screen corresponding to an audio prompt or to a voter selection made in response to an audio prompt.

64. A method for operating a voting check-in system in an electronic voting system programmed for election contests, said voting check-in system including a display screen and a transportable medium generation unit, said method comprising the steps of:
entry of voter data;
searching stored eligible voter information data;
display of stored eligible voter information matching entered voter data;
generation of a transportable medium with stored data;
transmission of stored data from the transportable medium to a polling station;
retrieval of a ballot matched to eligible voter information data utilizing the stored data on the transportable medium; and
display of the ballot at the voting station.

65. The method of claim 64 further comprising:
entry of voter data selected from the group consisting of: reading information stored on a state identification card, reading information stored on a state driver's license.

66. The method of claim 64 wherein the entry of voter data comprises:
providing fingerprint information and storing the fingerprint information digitally.

65. The method of claim 64 further comprising:
entry of voter verification of stored eligible voter information matching entered voter data.

66. The method of claim 65 further comprising:
signature information provided by the voter and stored digitally in response to the display of stored eligible voter information matching entered voter data.

67. The method of claim 65 further comprising:
fingerprint information provided by the voter and stored digitally in response to the display of stored eligible voter information matching entered voter data.

68. The method of claim 64 wherein generation of a transportable medium with stored data further comprises:
generation of a card containing stored data.

69. The method of claim 68 wherein the card is a magnetic card containing stored information.

70. The method of claim 64 wherein the generation of a transportable medium with stored data further comprises:
storing voter specific information on the card.

71. The method of claim 64 wherein the generation of a transportable medium with stored data further comprises:
storing ballot specific information on the card.

72. The method of claim 64 wherein the generation of a transportable medium with stored data further comprises:
storing a unique number on the card.

73. The method of claim 64 wherein transmission of stored data from the transportable medium to a polling station further comprises:
reading the stored information with a magnetic card reader.

74. The method of claim 64 wherein retrieval of a ballot matched to eligible voter information data utilizing the stored data on the transportable medium further comprises:
retrieving the ballot information from a polling place server.

75. The method of claim 65 wherein display of the ballot at the voting station includes providing audio prompts corresponding to the matched ballot, the audio prompts suitable for a visually impaired voter allowing the voter to make selections by non-visual means.

76. The method of claim 65 wherein eligible voter information includes voter information for a particular precinct.

77. The method of claim 65 wherein eligible voter information includes voter information for a region extending beyond a particular precinct.

78. The method of claim 65 wherein eligible voter information includes voter information for a at least a one county.

79. The method of claim 65 wherein eligible voter information includes voter information for at least a one state.

80. The method of claim 65 wherein eligible voter information includes voter information for a nation.

81. The method of claim 65 further comprising entry of data to define a provisional voter if no stored information matches entry of voter data.

82. The method of claim 65 wherein entry of voter data further comprises selection of visually impaired option.

83. The method of claim 65 further comprising:
display of at least one ballot.

84. The method of claim 83 further comprising:
selection of ballot.

86. The method of claim 65 further comprising:
automatic generation of data reports related to voting activity at a particular location.
